(19) United States
(12) Patent Application Publication
(10) Pub. No.: US 2026/0101400 A1
(43) Pub. Date: Apr. 9, 2026

(54) ELECTRONIC DEVICE FOR ADJUSTING STRENGTH OF SIGNAL OF SHORT-RANGE WIRELESS COMMUNICATION AND METHOD FOR THE SAME

(71) Applicant: Samsung Electronics Co., Ltd., Suwon-si (KR)

(72) Inventors: Hyunkee MIN, Suwon-si (KR); Wonbin PARK, Suwon-si (KR); Kyoungsun LEE, Suwon-si (KR); Muyeol LEE, Suwon-si (KR); Seonggeon CHO, Suwon-si (KR); Minsoo KIM, Suwon-si (KR); Seonghwan KIM, Suwon-si (KR); Sujeong BAEK, Suwon-si (KR); Eonji LEE, Suwon-si (KR)

(21) Appl. No.: 19/357,737

(22) Filed: Oct. 14, 2025

Related U.S. Application Data
(63) Continuation of application No. PCT/KR2025/015367, filed on Sep. 29, 2025.

(30) Foreign Application Priority Data
Oct. 7, 2024 (KR) 10-2024-0135753
Nov. 20, 2024 (KR) 10-2024-0166306

(51) Int. Cl. H04W 76/15; H04W 4/80; H04W 24/08

(52) U.S. Cl. CPC H04W 76/15; H04W 4/80; H04W 24/08

(57) ABSTRACT

An electronic device is provided. The electronic device includes a plurality of antennas, communication circuitry supporting short-range wireless communication, memory, comprising one or more storage media, storing instructions, and at least one processor communicatively coupled to the plurality of antennas, the communication circuitry, and the memory, wherein the instructions, when executed by the at least one processor individually or collectively, cause the electronic device to connect to an external electronic device disposed in a vehicle through the short-range wireless communication, and control the communication circuitry to reduce a strength of a signal output through the plurality of antennas, based on a temperature of the electronic device being equal to or greater than a specified value and a quality of a signal transmitted by the external electronic device being equal to or greater than a first value.

### CROSS-REFERENCE TO RELATED APPLICATION(S)

This application is a continuation application, claiming priority under 35 U.S. C. § 365(c), of an International application No. PCT/KR2025/015367, filed on Sep. 29, 2025, which is based on and claims the benefit of a Korean Patent Application number 10-2024-0135753, filed on Oct. 7, 2024, in the Korean intellectual Property Office, and of a Korean patent application number 10-2024-0166306, filed on Nov. 20, 2024, in the Korean Intellectual Property Office, the disclosure of each of which is incorporated by reference herein in its entirety.

### TECHNICAL FIELD

The disclosure relates to an electronic device and an operating method thereof. More particularly, the disclosure relates to an electronic device for adjusting the strength of a short-range wireless communication signal.

### BACKGROUND ART

With the supply of various electronic devices, the speed of wireless communication available by various electronic devices has been improved. Among wireless communications supported by recent electronic devices, institute of electrical and electronic engineers (IEEE) 802.11 wireless local area network (WLAN) (or wireless fidelity (Wi-Fi)) is a standard for implementing a high-speed wireless connection in various electronic devices. Initial Wi-Fi was able to support a transmission speed of up to 1 to 9 megabits per second (Mbps), while Wi-Fi 6 (or IEEE 802.11ax) is able to support a transmission speed of up to about 10 gigabits per second (Gbps).

An electronic devices may support various services (e.g., a ultra high definition (UHD) video streaming service, an augmented reality (AR) service, a virtual reality (VR) service, or a mixed reality (MR) service) using relatively large-capacity data through wireless communication that supports a high transmission speed. Particularly, in recent years, an electronic device may be connected to an infotainment system configured in a vehicle through short-range wireless communication to perform various services (e.g., a navigation service and a content providing service) related to the vehicle. The above information is presented as background information only to assist with an understanding of the disclosure. No determination has been made, and no assertion is made, as to whether any of the above might be applicable as prior art with regard to the disclosure.

### DISCLOSURE OF INVENTION

Aspects of the disclosure are to address at least the above-mentioned problems and/or disadvantages and to provide at least the advantages described below. Accordingly, an aspect of the disclosure is to an electronic device and an operating method for adjusting the strength of a short-range wireless communication signal.

Additional aspects will be set forth in part in the description which follows and, in part, will be apparent from the description, or may be learned by practice of the presented embodiments.

An electronic device may be connected with an external electronic device included in a vehicle through short-range wireless communication to transmit and/or receive data related to a service related to the vehicle through the short-range wireless communication. The electronic device needs to continuously maintain a connection with the external electronic device in order to perform the service related to the vehicle. The electronic device consumes power and generate heat due to the connection with the external electronic device, and is connected to a power supply device providing power that is included in the vehicle or separately exists via a wire and/or wirelessly. The electronic device generates heat due to charging, and when the temperature of the electronic device continuously increases, restriction (or throttling) occurs in performing various functions including a service related to the short-range wireless communication.

Additional aspects will be set forth in part in the description which follows and, in part, will be apparent from the description, or may be learned by practice of the presented embodiments.

In accordance with another aspect of the disclosure, an electronic device is provided. The electronic device includes a plurality of antennas, communication circuitry supporting short-range wireless communication, memory, comprising one or more storage media, storing instructions, and at least one processor communicatively coupled to the plurality of antennas, the communication circuitry and the memory, wherein the instructions, when executed by the at least one processor individually or collectively, cause the electronic device to connect to an external electronic device disposed in a vehicle through the short-range wireless communication, and control the communication circuitry to reduce a strength of a signal output through the plurality of antennas, based on a temperature of the electronic device being equal to or greater than a specified value and a quality of a signal transmitted by the external electronic device being equal to or greater than a first value.

In accordance with another aspect of the disclosure, one or more non-transitory computer-readable storage media storing at least one program including instructions to, when executed by at least one processor of the electronic device individually or collectively, cause the electronic device to perform operations are provided. The operations include connecting to an external electronic device disposed in a vehicle through short-range wireless communication, and reducing a strength of a signal output through a plurality of antennas, based on a temperature of the electronic device being equal to or greater than a specified value and a quality of a signal transmitted by the external electronic device being equal to or greater than a first value.

In accordance with another aspect of the disclosure, an operating method of an electronic device is provided. The operating method includes connecting to an external electronic device disposed in a vehicle through short-range wireless communication, and reducing a strength of a signal output through a plurality of antennas, based on a temperature of the electronic device being equal to or greater than a specified value and a quality of a signal transmitted by the external electronic device being equal to or greater than a first value.

An electronic device and an operating method of the electronic device according to an embodiment may identify the temperature of the electronic device and the quality of a signal transmitted by an external electronic device when connected to an external electronic device inside a vehicle through short-range wireless communication. When the temperature of the electronic device is equal to or greater than a specified value and the quality of the signal is equal to or greater than a specified value, the electronic device may reduce the strength of a signal output through an antenna of the electronic device, or may output and/or receive a signal through a single antenna of a plurality of antennas. Accordingly, the electronic device may reduce heat generation resulting from performing the short-range wireless communication, thereby preventing degradation in the performance of the short-range wireless communication or disconnection of the short-range wireless communication due to an increase in the temperature of the electronic device.

Other aspects advantages, advantages, and salient features of disclosure will become apparent to those skilled in the art from the following detailed description, which taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment of the disclosure;

FIG. 2 illustrates an electronic device and an external electronic device according to an embodiment of the disclosure;

FIG. 3 is a block diagram of an electronic device according to an embodiment of the disclosure;

FIG. 4 is a flowchart illustrating an example in which an electronic device controls a strength of a signal output through a plurality of antennas according to an embodiment of the disclosure;

FIG. 5 is a flowchart illustrating an example in which an electronic device controls a strength of a signal output through a plurality of antennas when a quality of a signal transmitted by an external electronic device satisfies a specified condition according to an embodiment of the disclosure;

FIG. 6 is a flowchart illustrating an example in which an electronic device adjusts a number of antennas for performing short-range wireless communication according to an embodiment of the disclosure;

FIG. 7 is a flowchart illustrating an example in which an electronic device adjusts a strength of a signal output through a plurality of antennas and a number of antennas for performing short-range wireless communication, based on a quality of a signal transmitted by an external electronic device and/or capability information about the external electronic device according to an embodiment of the disclosure;

FIG. 8 is a flowchart illustrating an example in which an electronic device adjusts a strength of a signal output through a plurality of antennas and a number of antennas for performing short-range wireless communication, based on the quality of a signal transmitted by an external electronic device and/or capability information about the external electronic device according to an embodiment of the disclosure; and

FIG. 9 is a flowchart illustrating an example in which an electronic device reduces the strength of a signal output through at least one antenna, based on the moving speed of the electronic device and the quality of a signal transmitted by an external electronic device according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth®chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

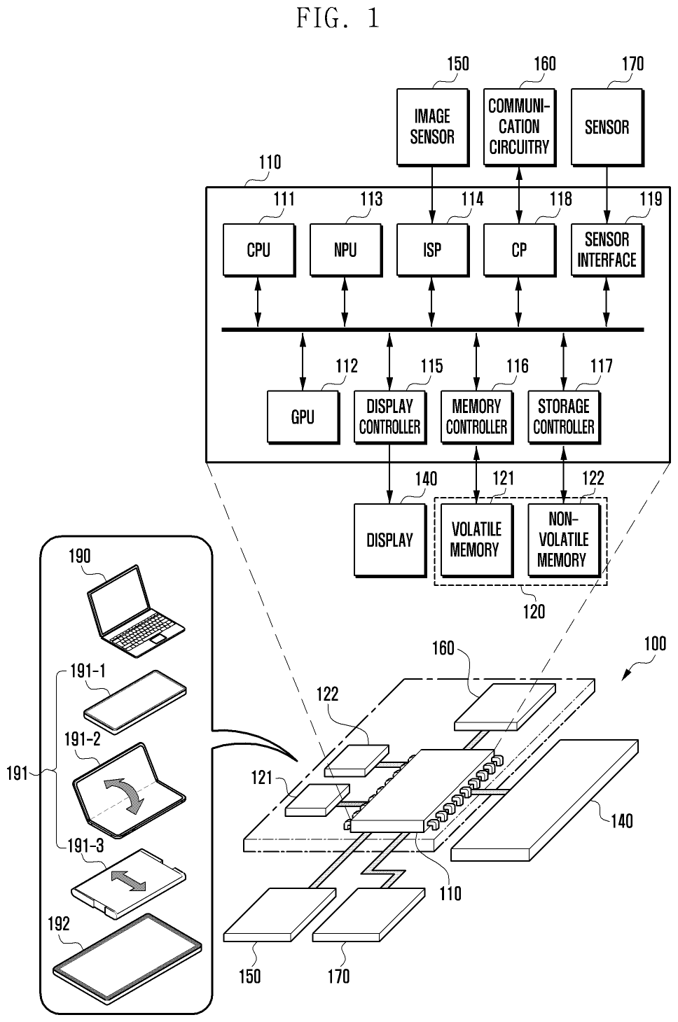

FIG. 1 illustrates a block diagram of an electronic device capable of performing the operations described herein according to an embodiment of the disclosure.

Referring to FIG. 1, an electronic device 100 may be one of various types of electronic devices, such as a notebook computer 190, smartphones 191 having various form factors (e.g., a bar-type smartphone 191-1, a foldable smartphone 191-2, or a slidable (or rollable) smartphone 191-3), a tablet personal computer (PC) 192, a cellular telephone (not shown), and any other similar computing devices (not shown). The components illustrated in FIG. 1, the relationships thereof, and the functions thereof are merely for illustration, and are not intended to limit the implementations described or claimed in the disclosure thereto. The electronic device 100 may be referred to as a mobile device, a user equipment, a multifunctional device, a portable device, or a server.

The electronic device 100 may comprise various components including at least one processor 110 (hereinafter, the processor 110), memory 120 (hereinafter, the memory 120), at least one display 140 (hereinafter, the display 140), at least one image sensor 150 (hereinafter, the image sensor 150), at least one communication circuitry 160 (hereinafter, the communication circuitry 160), and/or at least one sensor 170 (hereinafter, the sensor 170). The aforementioned components are merely of an example. For example, the electronic device 100 may comprise other components (e.g., a power management integrated circuitry (PMIC), an audio processing circuitry, an antenna, a rechargeable battery, or an input/output interface). For example, some components may be omitted from the electronic device (100). For example, some components may be integrated into one component.

The processor 110 may be implemented as one or more integrated circuit (or circuitry) (IC) chips and may perform various data processing. The processor 110 may include at least one electrical circuitry and may process instructions (or program, data, and so on) stored in the memory 120 individually or collectively in a distributed manner. The processor 110 may include a processor assembly that includes one or more processing circuitries. The processor may include any processing circuitry that may be operative for controlling operations and performance of one or more components (e.g., the memory 120, a display 140, the image sensor 150, the communication circuitry 160, and/or the sensor 170) of the electronic device. For example, the processor 110 (e.g., an application processor (AP)) may be implemented as a system on chip (SoC) (e.g., one chip or chipset). For example, the processor 110 may be implemented as a plurality of cores (or at least one core circuitry), a plurality of chips, or a plurality of chipsets. For example, the processor 110 may comprise one or more processing circuitry. For example, the processor 110 may comprise one or more processing circuitry which are individually and/or collectively configured to perform various functions of the disclosure. As a non-limiting example, at least a portion of the processor 110 may be included in a first chip of the electronic device 100 and at least another portion of the processor 110 may be included in a second chip of the electronic device 100 different from the first chip of the electronic device 100.

For example, the processor 110 may comprise a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely of an example. For example, the processor 110 may further comprise other components. For example, some components of the processor 110 may be omitted from the processor 110. For example, some components of the processor 110 may be included as separate components of the electronic device 100 outside the processor 110. For example, some components of the processor 110 (e.g., the memory controller 116) may be included in other components of the electronic device 100 (e.g., at least a portion of the memory 120, an interface (e.g., usable for connecting to at least one component of the electronic device 100), the display 140, and/or the image sensor 150).

The processor 110 may cause other components of the electronic device 100 to perform various operations by executing instructions stored in the memory 120. The CPU 111 (or a central processing circuitry) may be configured to control the components of the processor 110 based on execution of instructions stored in the memory 120 (e.g., the volatile memory 121 and/or the non-volatile memory 122). The GPU 112 (or a graphic processing circuitry) may be configured to execute parallel computations (e.g., rendering). The NPU 113 (or a neural processing circuitry, or an artificial intelligence (AI) chip) may be configured to execute operations (e.g., convolution computations) for an artificial intelligence model. The ISP 114 (or an image signal processing circuitry) may be configured to process a raw image obtained from the image sensor 150 in a format suitable for a component in the electronic device 100 or a component of the processor 110. The display controller 115 (or a display control circuitry, or a display processing unit (DPU)) may be configured to process an image obtained from the CPU 111, the GPU 112, the ISP 114, or the memory 120 (e.g., the volatile memory 121) in a format suitable for the display 140. The memory controller 116 (or a memory control circuitry) may be configured to control reading data from the volatile memory 121 and writing data to the volatile memory 121. The storage controller 117 (or a storage control circuitry) may be configured to control reading data from the non-volatile memory 122 and writing data to the non-volatile memory 122. The CP 118 (or a communication processing circuitry) may be configured to process data obtained from a component of the processor 110 in a format suitable for transmission to another electronic device via the communication circuitry 160, or to process data obtained from another electronic device via the communication circuitry 160 in a format suitable for processing of the component of the processor 110. For example, the communication circuitry 160 may comprise one or more communication circuitry. The sensor interface 119 (or a sensing data processing circuitry, a sensor hub) may be configured to process data on a state of the electronic device 100 and/or a state around the electronic device 100, obtained through the sensor 170, in a format suitable for a component of the processor 110.

The memory 120 may comprise one or more storage mediums (or one or more storage devices). For example, the memory 120 may include a memory assembly that includes one or more storage mediums. For example, the one or more storage mediums may comprise a permanent memory (e.g., the non-volatile memory 122) such as a hard drive, a flash memory, a read-only memory (ROM), a semi-permanent memory (e.g., the volatile memory 121) such as a random access memory (RAM), a storage (or a storage assembly) of any other suitable type, or any combination thereof. The memory 120 may comprise a cache memory which is a memory of one or more different types used to store data for performing a function or feature of the electronic device 100 at least temporarily. As a non-limiting example, the cache memory may be included in the processor 110. The memory 120 may be fixedly embedded within the electronic device 100, or may be incorporated onto one or more suitable types of components that may be repeatedly inserted into the electronic device 100, and removed from the electronic device 100 (e.g., a subscriber identity module (SIM) card, and/or a secure digital (SD) card).

For example, the memory 120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 110. For example, the memory 120 may store instructions callable by an application programming interface (API). For example, the memory 120 may store instructions in a library.

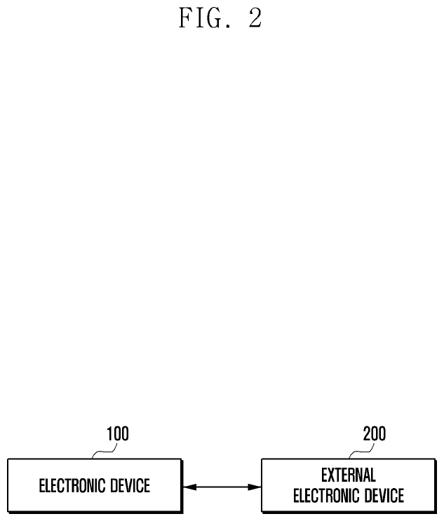

FIG. 2 illustrates an electronic device and an external electronic device according to an embodiment of the disclosure.

Referring to FIG. 2, the electronic device (e.g., the electronic device 100 of FIG. 1) and the external electronic device 200 may be connected via short-range wireless communication. The short-range wireless communication may refer to a wireless local area network (WLAN) defined in IEEE 802.11. To be connected with the external electronic device 200 via the short-range wireless communication, the electronic device 100 may perform an operation of discovering the external electronic device 200. For example, the electronic device 100 may broadcast a probe request frame via the short-range wireless communication, and the external electronic device 200 may transmit a probe response frame to the electronic device 100 upon receiving the probe request frame. The electronic device 100 may discover the external electronic device 200 upon receiving the probe response frame.

The electronic device 100 may perform an authentication procedure, an association procedure, and/or a security configuration procedure with the external electronic device 200 upon discovering the external electronic device 200, and may complete a connection with the external electronic device 200 via the short-range wireless communication upon completing the foregoing procedures.

The electronic device 100 and the external electronic device 200 may be directly connected via the short-range wireless communication without going through an access point (AP). According to an embodiment, the electronic device 100 and the external electronic device 200 may be connected via Wi-Fi Direct or Wi-Fi Aware.

The electronic device 100 may transmit data to the external electronic device 200 via the short-range wireless communication, and may receive data transmitted by the external electronic device 200 via the short-range wireless communication.

According to an embodiment, the external electronic device 200 may refer to an electronic device that exists in a vehicle, and may also refer to an electronic device that is not included in a vehicle.

According to an embodiment, the external electronic device 200 may be an electronic device included in a vehicle (e.g., a car or a motorcycle), and may be an electronic device supporting short-range wireless communication. For example, the external electronic device 200 may be an electronic device included in a vehicle, and may be an electronic device capable of controlling a function that the vehicle is able to provide (e.g., an air conditioning function, a content providing function, a function of controlling the vehicle, or a control function using a voice command). When the external electronic device 200 is configured as an electronic device included in a vehicle, the external electronic device 200 may be referred to by various terms, such as a car kit, an infotainment system, or a head unit.

Both the electronic device 100 and the external electronic device 200 are present in the vehicle, and may be connected through the short-range wireless communication. The electronic device 100 may perform a service related to the vehicle by being connected to the external electronic device 200. According to an embodiment, the electronic device 100 may transmit information related to a navigation service to the external electronic device 200 in order to perform the navigation service for guiding the vehicle to a destination. According to another embodiment, the electronic device 100 may transmit information related to content (e.g., a sound or an image) to the external electronic device 200 in order to output the content via a speaker or a display of the vehicle. Here, the electronic device 100 may need to maintain the connection with the external electronic device 200 through the short-range wireless communication in order to perform a service related to the vehicle. Maintaining the connection through the short-range wireless communication may increase power consumption of the electronic device 100, and may significantly increase heat generation. In particular, when the electronic device 100 is connected with a charger (e.g., a wireless charger or a wired charger) capable of providing power to the electronic device 100, heat generation due to power consumption caused by performing the short-range wireless communication may significantly increase. When the temperature of the electronic device 100 significantly increases, the electronic device 100 may release the connection through the short-range wireless communication, and the quality of the service related to the vehicle may be reduced or the service related to the vehicle may not be performed.

Hereinafter, examples in which the electronic device 100 reduces heat generation in a state of being connected to the external electronic device 200 included in the vehicle to thereby prevent (or reduce) a decrease in the quality of a service related to the vehicle or the inability to perform the service are described.

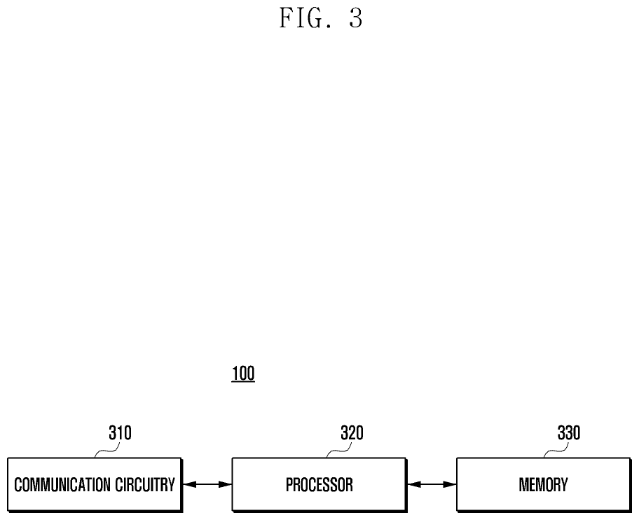

FIG. 3 is a block diagram of an electronic device according to an embodiment of the disclosure.

Referring to FIG. 3, the electronic device (e.g., the electronic device 100 of FIG. 1) may include communication circuitry 310 (e.g., the communication circuit 160 of FIG. 1), a processor 320 (e.g., the processor 110 of FIG. 1), and/or memory 330 (e.g., the memory 120 of FIG. 1).

The communication circuitry 310 may be a communication circuit that supports short-range wireless communication. The short-range wireless communication may include various short-range wireless communications that the electronic device 100 is able to support. For example, the short-range wireless communication may be Wi-Fi.

The communication circuitry 310 may include various circuit structures used for modulating and/or demodulating a signal in the electronic device 100. For example, the communication circuitry 310 may modulate a baseband signal into a radio-frequency (RF) signal to be output through at least one antenna among a plurality of antennas (not shown), or may demodulate an RF signal received through at least one antenna into a baseband signal to transmit the baseband signal to the processor 320.

The communication circuitry 310 may be electrically (or operatively) connected with the plurality of antennas, and may support a multiple-input and multiple-output (MIMO) mode using a plurality of antennas. The MIMO mode may refer to a mode in which a plurality of signals including packets generated by dividing data to be transmitted is output through a plurality of antennas or a mode in which a plurality of signals including packets generated by dividing data to be received through a plurality of antennas is received through the plurality of antennas.

Alternatively, the communication circuitry 310 may support a single-input and single-output (SISO) mode using one antenna among a plurality of antennas. The SISO mode may refer to a mode in which a signal including data to be transmitted is output through a single antenna or a mode in which a signal is received through a single antenna.

The processor 320 may be electrically or operatively connected with the communication circuitry 310 to control the communication circuitry 310. The processor 320 may include at least one processor, and the at least one processor may separately or collectively perform the following operations. The processor 320 may be the processor 110 illustrated in FIG. 1. Alternatively, the processor 320 may be a processor configured in the communication circuitry 310, and when the processor 320 is configured in the communication circuitry 310, the processor 320 may be referred to as a core.

The memory 330 may store instructions executable by the processor 320. The following operation of the processor 320 may be performed according to execution of the instructions stored on the memory 330.

The processor 320 may control the communication circuitry 310 to retrieve an external electronic device (e.g., the external electronic device 200 of FIG. 2) to be connected via the short-range wireless communication.

According to an embodiment, the external electronic device 200 may be an electronic device included in a vehicle (e.g., a car or a motorcycle), and may be an electronic device supporting short-range wireless communication. For example, the external electronic device 200 may be an electronic device included in a vehicle, and may be an electronic device capable of controlling a function that the vehicle is able to provide (e.g., an air conditioning function, a content providing function, a function of controlling the vehicle, and/or a control function using a voice command). When the external electronic device 200 is configured as an electronic device included in a vehicle, the external electronic device 200 may be referred to by various terms, such as a car kit, an infotainment system, or a head unit.

The processor 320 may retrieve the external electronic device 200 to perform a service related to the vehicle. The service related to the vehicle may include, for example, a navigation service for guiding the vehicle to a destination or a content playback service (or a content streaming service) of outputting content by using an output device (e.g., a speaker or a display) included in the vehicle. To perform the service related to the vehicle in association with the external electronic device 200, the processor 320 may be required to connect with the external electronic device 200 via the short-range wireless communication, and may perform an operation of connecting to the external electronic device 200 through the short-range wireless communication.

The processor 320 may control the communication circuitry 310 to broadcast a probe request message in order to retrieve the external electronic device 200. The probe request message may include information about the electronic device 100. According to an embodiment, the probe request message may include various pieces of identification information (e.g., a MAC address) for distinguishing the electronic device 100 from other electronic devices and/or capability information related to the short-range wireless communication of the electronic device 100. When receiving the probe request message, the external electronic device 200 may transmit a probe response message to the electronic device 100 in response to the probe request message. When receiving the probe response message, the processor 320 may succeed in retrieving the external electronic device 200.

The processor 320 may perform an authentication procedure, an association procedure, and/or a security configuration procedure with the external electronic device 200 upon discovering the external electronic device 200, and may complete a connection with the external electronic device 200 through the short-range wireless communication upon completing the foregoing procedures.

The processor 320 may complete the connection with the external electronic device 200 through the short-range wireless communication, may control the communication circuitry 310 to transmit data related to the service related to the vehicle to the external electronic device 200 through the short-range wireless communication, and may receive data related to the service related to the vehicle from the external electronic device 200.

As described above, the electronic device 100 may need to maintain the connection with the external electronic device 200 through the short-range wireless communication in order to perform the service related to the vehicle. Maintaining the connection with the external electronic device 200 through the short-range wireless communication may increase power consumption of the electronic device 100, and may significantly increase heat generation. In particular, when the electronic device 100 is connected with a charger (e.g., a wireless charger or a wired charger) capable of providing power to the electronic device 100, heat generation due to power consumption caused by performing the short-range wireless communication may significantly increase. When the temperature of the electronic device 100 significantly increases, the electronic device 100 may release the connection through the short-range wireless communication, and the quality of the service related to the vehicle may be reduced or the service related to the vehicle may not be performed.

To reduce or prevent the foregoing situation, the processor 320 may perform an operation of reducing heat generation.

According to an embodiment, the processor 320 may identify (or monitor, detect, or sense) the temperature of the electronic device 100. The processor 320 may identify the temperature of the electronic device 100 by using temperature sensors (e.g., the sensor 170 of FIG. 1) disposed in various parts of the electronic device 100. The processor 320 may identify whether the temperature of the electronic device 100 is equal to or higher than (or exceeds) a specified value, and when the temperature of the electronic device 100 is equal to or higher than (or exceeds) the specified value, the processor 320 may perform the operation of reducing heat generation.

According to an embodiment, when the temperature of the electronic device 100 is equal to or higher than the specified value, the processor 320 may identify whether the electronic device 100 is being charged. When the temperature of the electronic device 100 is equal to or higher than (or exceeds) the specified value and the electronic device 100 is being charged, the processor 320 may perform the operation of reducing heat generation. When the electronic device 100 is being charged, heat generation due to charging may be very significant, and thus the processor 320 may perform the operation of reducing heat generation to maintain the connection with the external electronic device 200 through the short-range wireless communication.

When the temperature of the electronic device 100 is equal to or higher than the specified value but the electronic device 100 is not being charged, the processor 320 may not perform the operation of reducing heat generation. When the electronic device 100 is not being charged, heat generation due to charging may not occur, and thus the processor 320 may not need to perform the operation of reducing heat generation in order to maintain the connection with the external electronic device 200 through the short-range wireless communication.

According to an embodiment, the processor 320 may perform the operation of reducing heat generation when the electronic device 100 is in at least one of a state in which the temperature of the electronic device 100 is equal to or higher than (or exceeds) the specified value and/or a state in which the electronic device 100 is being charged.

According to an embodiment, the processor 320 may perform the operation of reducing heat generation regardless of the temperature of the electronic device 100. For example, the processor 320 may perform the operation of reducing heat generation when detecting that the electronic device 100 is present in the vehicle.

The processor 320 may perform the operation of reducing heat generation, based on identifying that the electronic device 100 is present in the vehicle. In one example, the processor 320 may perform the operation of reducing heat generation, based on identifying that the electronic device 100 is performing a service related to the vehicle (e.g., executing an application for opening and closing a door of the vehicle). In another example, the processor 320 may identify the moving speed of the electronic device 100, and may perform the operation of reducing heat generation when the moving speed is equal to or greater than (or exceeds) a specified value.

The processor 320 may reduce the strength of a signal output through the plurality of antennas as part of the operation of reducing heat generation. When the temperature of the electronic device 100 is the specified value or higher, the processor 320 may identify the quality of a signal transmitted by the external electronic device 200 through the short-range wireless communication. The signal transmitted by the external electronic device 200 through the short-range wireless communication may be any one of various signals transmitted through the short-range wireless communication, and for example, the signal transmitted by the external electronic device 200 through the short-range wireless communication may be a signal including data related to the vehicle or a control signal (e.g., a beacon signal) of the short-range wireless communication.

According to an embodiment, the processor 320 may identify the quality of the signal by identifying a parameter (e.g., a received signal strength indicator (RSSI), a signal-to-noise ratio (SNR), a link speed, and/or an estimated throughput) indicating the quality of the signal.

The processor 320 may identify whether the quality of the signal transmitted by the external electronic device 200 through the short-range wireless communication is equal to or greater (or exceeds) than a specified value, and may reduce the strength of the signal output through the plurality of antennas when the quality of the signal transmitted by the external electronic device 200 through the short-range wireless communication is equal to or greater than (or exceeds) the specified value. The specified value may refer to a level (or value) indicating (or denoting) that the electronic device 100 and the external electronic device 200 may smoothly perform the short-range wireless communication. The quality of the signal transmitted by the external electronic device 200 through the short-range wireless communication being equal to or greater than (or exceeds) the specified value may indicate a situation in which the electronic device 100 and the external electronic device 200 may smoothly perform the short-range wireless communication. Therefore, the processor 320 may control the communication unit 310 to reduce the strength of the signal output through the plurality antennas. The communication circuitry 310 may reduce the strength of the signal output through the antennas to thereby reduce power required to amplify the signal, and heat generation may also be reduced as power consumption is reduced.

The processor 320 may reduce the strength of the signal output through the plurality of antennas when the electronic device 100 is performing the service related to the vehicle including the external electronic device 200 and the quality of the signal transmitted by the external electronic device 200 through the short-range wireless communication is equal to or greater than (or exceeds) the specified value.

The processor 320 may reduce the strength of the signal output through the plurality of antennas when the moving speed of the electronic device 100 is equal to or greater than the specified value and the quality of the signal transmitted by the external electronic device 200 through the short-range wireless communication is equal to or greater than (or exceeds) the specified value.

The processor 320 may adjust (or reduce) the number of antennas used for performing the short-range wireless communication among the plurality of antennas as part of the operation of reducing heat generation. According to an embodiment, the processor 320 may deactivate a communication circuit (e.g., a front-end module (FEM)) electrically (or operatively) connected to an antenna that is not used for performing the short-range wireless communication (or a deactivated antenna) as part of an operation of adjusting (or reducing) the number of antennas for performing the short-range wireless communication. By deactivating the communication circuit, components that process a signal may be deactivated. For example, the communication circuit may deactivate an amplifier that amplifies a signal of the short-range wireless communication. When the number of antennas used for performing the short-range wireless communication is adjusted (or reduced), the number of signals that require amplification by the communication circuitry 310 may be reduced, the communication circuitry 310 may reduce power used to amplify a signal, and heat generation may also be reduced as power consumption is reduced.

The processor 320 may receive capability information about the external electronic device 200 through the short-range wireless communication. The capability information about the external electronic device 200 may refer to information indicating a function that the external electronic device 200 supports or does not support among various functions of the short-range wireless communication. The capability information about the external electronic device 200 may be received during a process (e.g., a discovery process or an association process) in which the electronic device 100 and the external electronic device 200 establish the connection through the short-range wireless communication, and may be included in a frame (e.g., an action frame) transmitted by the external electronic device 200 after the electronic device 100 and the external electronic device 200 complete the connection through the short-range wireless communication. According to an embodiment, the capability information about the external electronic device 200 may be included in a header of a signal transmitted through a medium access control (MAC) layer.

According to an embodiment, the capability information about the external electronic device 200 may include information indicating whether to support a function related to transmission and/or reception of a signal using the plurality of antennas. According to an embodiment, the capability information about the external electronic device 200 may include the number (N_{SS}) of spatial streams supported by the external electronic device 200. When receiving the capability information about the external electronic device 200 in which the number of spatial streams supported by the external electronic device 200 is indicated (or displayed) as 1, the processor 320 may identify that the external electronic device 200 does not support transmission and/or reception of a signal using the plurality of antennas.

When the external electronic device 200 does not support the short-range wireless communication using a plurality of spatial streams (or when the number of spatial streams supported by the external electronic device 200 is 1), the processor 320 may control the communication circuitry 310 to perform the short-range wireless communication through one of the plurality of antennas. Performing the short-range wireless communication through one of the plurality of antennas may refer to the communication circuitry 310 operating in the SISO mode. When the temperature of the electronic device 100 is equal to or higher than (or exceeds) the specified value and the external electronic device 200 does not support the short-range wireless communication using the plurality of spatial streams (or when the number of spatial streams supported by the external electronic device 200 is 1), the processor 320 may control the communication circuitry 310 to perform the short-range wireless communication through one of the plurality of antennas.

The processor 320 may also determine whether to perform the short-range wireless communication through one of the plurality of antennas, based on the quality of the signal transmitted by the external electronic device 200 and/or the capability information about the external electronic device 200.

According to an embodiment, when the external electronic device 200 does not support the short-range wireless communication using the plurality of spatial streams (or when the number of spatial streams supported by the external electronic device 200 is 1) and the quality of the signal transmitted by the external electronic device 200 is equal to or greater than (or exceeds) the specified value, the processor 320 may control the communication circuitry 310 to perform the short-range wireless communication through one antenna of the plurality of antennas. The quality of the signal transmitted by the external electronic device 200 being equal to or greater than (or exceeds) the specified value means that the quality of the short-range wireless communication performed by the electronic device 100 and the external electronic device 200 is high, in which case the quality of the short-range wireless communication may satisfy a required quality even when the short-range wireless communication is performed using one antenna. Therefore, the processor 320 may control the communication circuitry 310 to perform the short-range wireless communication through one antenna of the plurality of antennas, thereby reducing power used by the communication circuitry 310 and heat generation.

According to an embodiment, when the external electronic device 200 does not support the short-range wireless communication using the plurality of spatial streams (or the number of spatial streams supported by the external electronic device 200 is 1) and the quality of the signal transmitted by the external electronic device 200 is less than or equal to (or below) the specified value, the processor 320 may control the communication circuitry 310 to receive a signal using two or more antennas among the plurality of antennas and transmit a signal to the external electronic device 200 using two or more antennas. Receiving a signal using two or more antennas among the plurality of antennas is for supporting a diversity Rx mode. The processor 320 may receive a signal by using two or more antennas among the plurality of antennas, thereby improving performance in receiving the signal transmitted by the external electronic device 200.

The processor 320 may determine whether to perform the short-range wireless communication through one of the plurality of antennas and whether to adjust (or reduce) the level of a signal output through at least one of the plurality of antennas, based on the quality of the signal transmitted by the external electronic device 200 and/or the capability information about the external electronic device 200.

According to an embodiment, the processor 320 may identify the quality of the signal transmitted by the external electronic device 200 and/or whether the external electronic device 200 supports the short-range wireless communication using the plurality of spatial streams.

When the external electronic device 200 does not support the short-range wireless communication using the plurality of spatial streams, the processor 320 may control the communication circuitry 310 to perform signal transmission using one of the plurality of antennas.

When the quality of the signal transmitted by the external electronic device 200 is equal to or greater than (or exceeds) a first value and the external electronic device 200 does not support the short-range wireless communication using the plurality of spatial streams, the processor 320 may control the communication circuitry 310 to perform transmission and/or reception of a signal using one antenna and to reduce the strength of the signal output through the one antenna. Transmission and/or reception of a signal using one antenna may refer to the communication circuitry 310 operating in the SISO mode.

When the quality of the signal transmitted by the external electronic device 200 is less than or equal to (or below) the first value and is equal to or greater than (or exceeds) a second value that is smaller than the first value and the external electronic device 200 does not support the short-range wireless communication using the plurality of spatial streams, the processor 320 may control the communication circuitry 310 to refrain from reducing the strength of a signal output through one antenna and to perform transmission and/or reception of a signal using one antenna. The second value may be a value corresponding to the required minimum quality (or performance) of the short-range wireless communication performed through signal transmission and/or reception using one antenna.

When the quality of the signal transmitted by the external electronic device 200 is less than or equal to (or below) the second value and the external electronic device 200 does not support the short-range wireless communication using the plurality of spatial streams, the processor 320 may control the communication circuitry 310 to refrain from reducing the strength of a signal output through one antenna and to perform transmission of a signal using one antenna and reception of a signal using two or more antennas among the plurality of antennas. Receiving a signal using two or more antennas among the plurality of antennas is for supporting the diversity Rx mode. The processor 320 may receive a signal by using two or more antennas among the plurality of antennas, thereby improving performance in receiving the signal transmitted by the external electronic device 200. Further, since the external electronic device 200 is unable to receive a signal through a plurality of antennas, the processor 320 may output a signal by using one antenna.

When the external electronic device 200 supports the short-range wireless communication using the plurality of spatial streams, the processor 320 may control the communication circuitry 310 to perform transmission and/or reception of a signal using the plurality of antennas. Transmission and/or reception of a signal using the plurality of antennas may refer to the communication circuitry 310 operating in the MIMO mode.

When the quality of the signal is equal to or greater than (or exceeds) a third value and the external electronic device 200 supports the short-range wireless communication using the plurality of spatial streams, the processor 320 may control the communication circuitry 310 to perform transmission and/or reception of a signal using the plurality of antennas and to reduce the strength of a signal transmitted through the plurality of antennas.

When the quality of the signal is less than or equal to (or below) the third value and the external electronic device 200 supports the short-range wireless communication using the plurality of spatial streams, the processor 320 may control the communication circuitry 310 to refrain from reducing the strength of a signal transmitted through the plurality of antennas and to perform transmission and/or reception of a signal using the plurality of antennas.

Through the foregoing method, the electronic device 100 may reduce unnecessary power consumption that occurs while performing the short-range wireless communication, thereby minimizing heat generation and reducing degradation in the performance of the short-range wireless communication due to heat generation.

When performing the foregoing operation of reducing heat generation (e.g., adjusting the strength of a signal output through an antenna and/or performing transmission and/or reception of a signal using one of the plurality of antennas), the processor 320 may not perform the operation of reducing heat when the electronic device 100 is not being charged.

When performing the operation of reducing heat generation, the processor 320 may perform a series of operations to enable the external electronic device 200 to also perform an operation of reducing heat generation. According to an embodiment, the processor 320 may transmit a signal for requesting a reduction in the strength of the signal transmitted by the external electronic device 200 to the external electronic device 200, based on identifying that the quality of the signal transmitted by the external electronic device 200 is equal to or greater than the first value. The signal for requesting the reduction in the strength of the signal transmitted by the external electronic device 200 may be included in a signal exchanged through the short-range wireless communication, and the external electronic device 200 may reduce the strength of the signal transmitted by the external electronic device 200, thereby reducing power used by the external electronic device 200.

Regarding the foregoing operation, the processor 320 may identify (or monitor) the quality of the signal transmitted by the external electronic device 200 every specified period, and may adjust the strength of an output signal in consideration of a changed quality when the quality of the signal changes. According to an embodiment, the processor 320 may reduce the strength of a signal output through an antenna, based on identifying that the quality of the signal transmitted by the external electronic device 200 changes from the first value or less to the first value or greater. According to another embodiment, the processor 320 may control the communication circuitry 310 to refrain from reducing the strength of a signal output through an antenna, based on identifying that the quality of the signal transmitted by the external electronic device 200 changes from the first value or greater to the first value or less. According to still another embodiment, the processor 320 may control the communication circuitry 310 to perform reception of a signal using a plurality of antennas, instead of performing reception of a signal using a single antenna, based on identifying that the quality of the signal transmitted by the external electronic device 200 changes from the second value or greater to the second value or less.

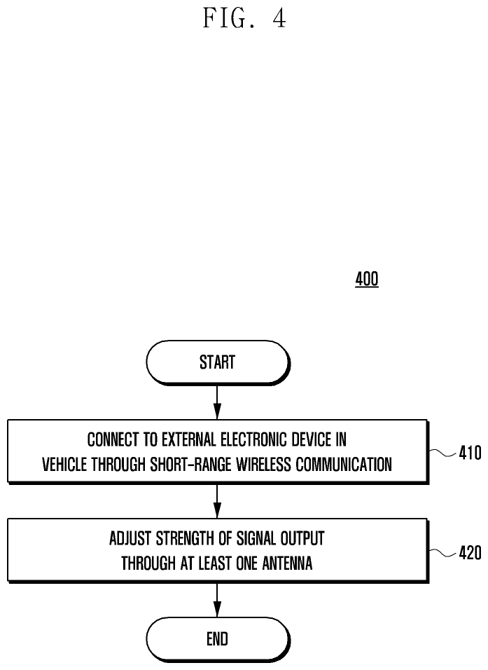

The foregoing content is described in more detail in flowcharts illustrated below in FIG. 4 to FIG. 9. It should be noted that examples illustrated in FIG. 4 to FIG. 9 are not different embodiments from an example described in FIG. 3 and that the examples illustrated in FIG. 4 to FIG. 9 may be combined with each other.

As described above, the processor 320 may control the operation of the short-range wireless communication to reduce heat generation. However, the processor 320 may control charging of the electronic device 100 to further reduce heat generation. According to an embodiment, the processor 320 may perform a series of operations to reduce the magnitude of a voltage or current received from the external electronic device 200. For example, the processor 320 may switch from a fast charging mode to a normal charging mode, thereby reducing the magnitude of the current or voltage received from the external electronic device 200.

FIG. 4 is a flowchart illustrating an example in which an electronic device controls a strength of a signal output through a plurality of antennas according to an embodiment of the disclosure.

Referring to the flowchart 400 of FIG. 4, in operation 410, the electronic device (e.g., the electronic device 100 of FIG. 3) may be connected to an external electronic device (e.g., the external electronic device 200 of FIG. 2) in a vehicle through short-range wireless communication.

According to an embodiment, the external electronic device 200 may be an electronic device included in a vehicle (e.g., a car or a motorcycle), and may be an electronic device supporting short-range wireless communication. For example, the external electronic device 200 may be an electronic device included in a vehicle, and may be an electronic device capable of controlling a function that the vehicle is able to provide (e.g., an air conditioning function, a content providing function, a function of controlling the vehicle, and/or a control function using a voice command). When the external electronic device 200 is configured as an electronic device included in a vehicle, the external electronic device 200 may be referred to by various terms, such as a car kit, an infotainment system, or a head unit.

The electronic device 100 may retrieve the external electronic device 200 to perform a service related to the vehicle. The service related to the vehicle may include, for example, a navigation service for guiding the vehicle to a destination or a content playback service (or a content streaming service) (e.g., Android Auto or CarPlay) of outputting content by using an output device (e.g., a speaker or a display) included in the vehicle. To perform the service related to the vehicle in association with the external electronic device 200, the electronic device 100 may be required to connect with the external electronic device 200 via the short-range wireless communication, and may perform an operation of connecting to the external electronic device 200 through the short-range wireless communication.

The electronic device 100 may perform an authentication procedure, an association procedure, and/or a security configuration procedure with the external electronic device 200 upon discovering the external electronic device 200, and may complete a connection with the external electronic device 200 through the short-range wireless communication upon completing the foregoing procedures.

The electronic device 100 may complete the connection with the external electronic device 200 through the short-range wireless communication, may control the communication circuitry 310 to transmit data related to the service related to the vehicle to the external electronic device 200 through the short-range wireless communication, and may receive data related to the service related to the vehicle from the external electronic device 200.

In operation 420, the electronic device 100 may adjust the strength of a signal output through at least one antenna.

According to an embodiment, the electronic device 100 may identify (or monitor, detect, or sense) the temperature of the electronic device 100. The electronic device 100 may identify the temperature of the electronic device 100 by using temperature sensors (e.g., the sensor 170 of FIG. 1) disposed in various parts of the electronic device 100. The electronic device 100 may identify whether the temperature of the electronic device 100 is equal to or higher than (or exceeds) a specified value, and when the temperature of the electronic device 100 is equal to or higher than (or exceeds) the specified value, the electronic device 100 may perform an operation of reducing heat generation.

According to an embodiment, when the temperature of the electronic device 100 is equal to or higher than the specified value, the electronic device 100 may identify whether the electronic device 100 is being charged. When the temperature of the electronic device 100 is equal to or higher than (or exceeds) the specified value and the electronic device 100 is being charged, the electronic device 100 may perform the operation of reducing heat generation. When the electronic device 100 is being charged, heat generation due to charging may be very significant, and thus the electronic device 100 may perform the operation of reducing heat generation to maintain the connection with the external electronic device 200 through the short-range wireless communication.

The electronic device 100 may reduce the strength of a signal output through a plurality of antennas as part of the operation of reducing heat generation. When the temperature of the electronic device 100 is the specified value or higher, the electronic device 100 may identify the quality of a signal transmitted by the external electronic device 200 through the short-range wireless communication. The signal transmitted by the external electronic device 200 through the short-range wireless communication may be any one of various signals transmitted through the short-range wireless communication, and for example, the signal transmitted by the external electronic device 200 through the short-range wireless communication may be a signal including data related to the vehicle or a control signal (e.g., a beacon signal) of the short-range wireless communication.

According to an embodiment, the electronic device 100 may identify the quality of the signal by identifying a parameter (e.g., a received signal strength indicator (RSSI), a signal-to-noise ratio (SNR), a link speed, and/or an estimated throughput) indicating the quality of the signal.

The electronic device 100 may identify whether the quality of the signal transmitted by the external electronic device 200 through the short-range wireless communication is equal to or greater (or exceeds) than a specified value, and may reduce the strength of the signal output through the plurality of antennas when the quality of the signal transmitted by the external electronic device 200 through the short-range wireless communication is equal to or greater than (or exceeds) the specified value. The specified value may refer to a level (or value) indicating (or denoting) that the electronic device 100 and the external electronic device 200 may smoothly perform the short-range wireless communication. The quality of the signal transmitted by the external electronic device 200 through the short-range wireless communication being equal to or greater than (or exceeds) the specified value may indicate a situation in which the electronic device 100 and the external electronic device 200 may smoothly perform the short-range wireless communication. Therefore, the electronic device 100 may control the communication unit 310 to reduce the strength of the signal output through the plurality antennas. The communication circuitry 310 may reduce the strength of the signal output through the antennas to thereby reduce power required to amplify the signal, and heat generation may also be reduced as power consumption is reduced.

The electronic device 100 may reduce the strength of the signal output through the plurality of antennas when the electronic device 100 is performing the service related to the vehicle including the external electronic device 200 and the quality of the signal transmitted by the external electronic device 200 through the short-range wireless communication is equal to or greater than (or exceeds) the specified value.

The electronic device 100 may reduce the strength of the signal output through the plurality of antennas when the moving speed of the electronic device 100 is equal to or greater than the specified value and the quality of the signal transmitted by the external electronic device 200 through the short-range wireless communication is equal to or greater than (or exceeds) the specified value.

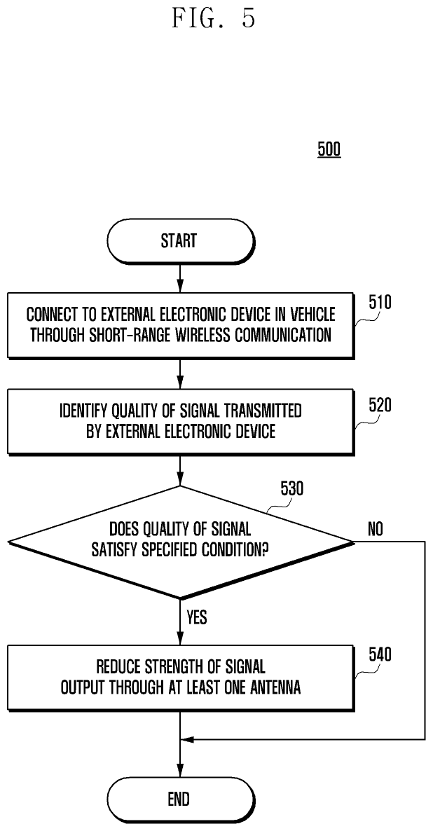

FIG. 5 is a flowchart illustrating an example in which an electronic device controls a strength of a signal output through a plurality of antennas when a quality of a signal transmitted by an external electronic device satisfies a specified condition according to an embodiment of the disclosure.

Referring to the flowchart 500 of FIG. 5, in operation 510, the electronic device (e.g., the electronic device 100 of FIG. 3) may be connected to the external electronic device (e.g., the external electronic device 200 of FIG. 2) in a vehicle through short-range wireless communication.

According to an embodiment, the external electronic device 200 may be an electronic device included in a vehicle (e.g., a car or a motorcycle), and may be an electronic device supporting short-range wireless communication. For example, the external electronic device 200 may be an electronic device included in a vehicle, and may be an electronic device capable of controlling a function that the vehicle is able to provide (e.g., an air conditioning function, a content providing function, a function of controlling the vehicle, and/or a control function using a voice command). When the external electronic device 200 is configured as an electronic device included in a vehicle, the external electronic device 200 may be referred to by various terms, such as a car kit, an infotainment system, or a head unit.

The electronic device 100 may retrieve the external electronic device 200 to perform a service related to the vehicle. The service related to the vehicle may include, for example, a navigation service for guiding the vehicle to a destination or a content playback service (or a content streaming service) of outputting content by using an output device (e.g., a speaker or a display) included in the vehicle. To perform the service related to the vehicle in association with the external electronic device 200, the electronic device 100 may be required to connect with the external electronic device 200 via the short-range wireless communication, and may perform an operation of connecting to the external electronic device 200 through the short-range wireless communication.

The electronic device 100 may perform an authentication procedure, an association procedure, and/or a security configuration procedure with the external electronic device 200 upon discovering the external electronic device 200, and may complete a connection with the external electronic device 200 through the short-range wireless communication upon completing the foregoing procedures.

The electronic device 100 may complete the connection with the external electronic device 200 through the short-range wireless communication, may control the communication circuitry 310 to transmit data related to the service related to the vehicle to the external electronic device 200 through the short-range wireless communication, and may receive data related to the service related to the vehicle from the external electronic device 200.

In operation 520, the electronic device 100 may identify the quality of a signal transmitted by the external electronic device 200.

The electronic device 100 may reduce the strength of a signal output through a plurality of antennas as part of an operation of reducing heat generation. When the temperature of the electronic device 100 is the specified value or higher, the electronic device 100 may identify the quality of a signal transmitted by the external electronic device 200 through the short-range wireless communication. The signal transmitted by the external electronic device 200 through the short-range wireless communication may be any one of various signals transmitted through the short-range wireless communication, and for example, the signal transmitted by the external electronic device 200 through the short-range wireless communication may be a signal including data related to the vehicle or a control signal (e.g., a beacon signal) of the short-range wireless communication.

According to an embodiment, the electronic device 100 may identify the quality of the signal by identifying a parameter (e.g., a received signal strength indicator (RSSI), a signal-to-noise ratio (SNR), a link speed, and/or an estimated throughput) indicating the quality of the signal.

In operation 530, the electronic device 100 may identify whether the quality of the signal satisfies a specified condition.

The specified condition may include a condition that the quality of the signal is equal to or greater than (or exceeds) a specified value.

In operation 540, the electronic device 100 may reduce the strength of a signal output through at least one antenna, based on whether the quality of the signal satisfying the specified condition (operation 530-Y).

The electronic device 100 may identify whether the quality of the signal transmitted by the external electronic device 200 through the short-range wireless communication is equal to or greater (or exceeds) than a specified value, and may reduce the strength of the signal output through the plurality of antennas when the quality of the signal transmitted by the external electronic device 200 through the short-range wireless communication is equal to or greater than (or exceeds) the specified value. The specified value may refer to a level (or value) indicating (or denoting) that the electronic device 100 and the external electronic device 200 may smoothly perform the short-range wireless communication. The quality of the signal transmitted by the external electronic device 200 through the short-range wireless communication being equal to or greater than (or exceeds) the specified value may indicate a situation in which the electronic device 100 and the external electronic device 200 may smoothly perform the short-range wireless communication. Therefore, the electronic device 100 may control the communication unit 310 to reduce the strength of the signal output through the plurality antennas. The communication circuitry 310 may reduce the strength of the signal output through the antennas to thereby reduce power required to amplify the signal, and heat generation may also be reduced as power consumption is reduced.

The electronic device 100 may reduce the strength of the signal output through the plurality of antennas when the electronic device 100 is performing the service related to the vehicle including the external electronic device 200 and the quality of the signal transmitted by the external electronic device 200 through the short-range wireless communication is equal to or greater than (or exceeds) the specified value.

The electronic device 100 may reduce the strength of the signal output through the plurality of antennas when the moving speed of the electronic device 100 is equal to or greater than a specified value and the quality of the signal transmitted by the external electronic device 200 through the short-range wireless communication is equal to or greater than (or exceeds) the specified value.

According to an embodiment, the electronic device 100 may determine the strength of the signal in view of the volume of traffic transmitted and/or received via the short-range wireless communication. For example, the electronic device 100 may determine the reduced strength of the signal as a strength for ensuring the success rate of data transmitted and/or received through the short-range wireless communication. The electronic device 100 may determine (or identify or calculate) an estimated throughput, based on the strength of the signal to be reduced and the speed of a link established between the electronic device 100 and the external electronic device 200, and may determine the strength of the signal so that the estimated throughput is equal to or greater than (or exceeds) the volume of traffic transmitted and/or received through the short-range wireless communication.

The electronic device 100 may refrain from reducing the strength of the signal output through the at least one antenna, based on the quality of the signal not satisfying the specified condition (530-N).

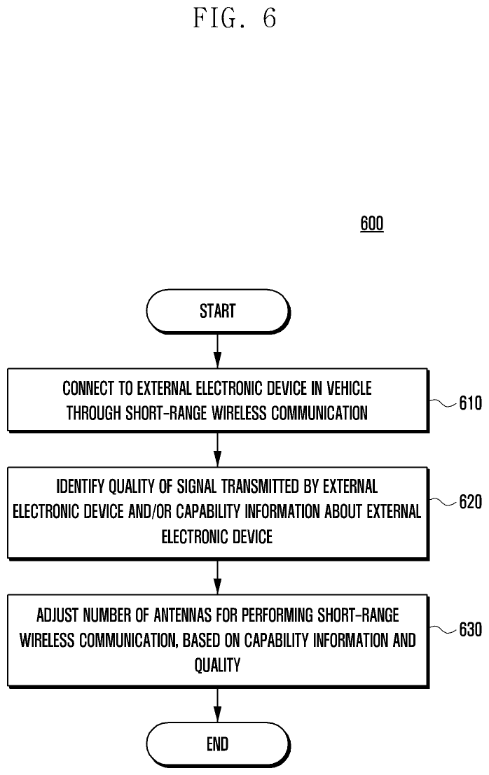

FIG. 6 is a flowchart illustrating an example in which an electronic device adjusts a number of antennas for performing short-range wireless communication according to an embodiment of the disclosure.

Referring to the flowchart 600 of FIG. 6, in operation 610, the electronic device (e.g., the electronic device 100 of FIG. 3) may be connected to an external electronic device (e.g., the external electronic device 200 of FIG. 2) in a vehicle through short-range wireless communication.

According to an embodiment, the external electronic device 200 may be an electronic device included in a vehicle (e.g., a car or a motorcycle), and may be an electronic device supporting short-range wireless communication. For example, the external electronic device 200 may be an electronic device included in a vehicle, and may be an electronic device capable of controlling a function that the vehicle is able to provide (e.g., an air conditioning function, a content providing function, a function of controlling the vehicle, and/or a control function using a voice command). When the external electronic device 200 is configured as an electronic device included in a vehicle, the external electronic device 200 may be referred to by various terms, such as a car kit, an infotainment system, or a head unit.

The electronic device 100 may retrieve the external electronic device 200 to perform a service related to the vehicle. The service related to the vehicle may include, for example, a navigation service for guiding the vehicle to a destination or a content playback service (or a content streaming service) of outputting content by using an output device (e.g., a speaker or a display) included in the vehicle. To perform the service related to the vehicle in association with the external electronic device 200, the electronic device 100 may be required to connect with the external electronic device 200 via the short-range wireless communication, and may perform an operation of connecting to the external electronic device 200 through the short-range wireless communication.

The electronic device 100 may perform an authentication procedure, an association procedure, and/or a security configuration procedure with the external electronic device 200 upon discovering the external electronic device 200, and may complete a connection with the external electronic device 200 through the short-range wireless communication upon completing the foregoing procedures.

The electronic device 100 may complete the connection with the external electronic device 200 through the short-range wireless communication, may control the communication circuitry 310 to transmit data related to the service related to the vehicle to the external electronic device 200 through the short-range wireless communication, and may receive data related to the service related to the vehicle from the external electronic device 200.

In operation 620, the electronic device 100 may identify the quality of a signal transmitted by the external electronic device 200 and capability information about the external electronic device 200.

The electronic device 100 may adjust (or reduce) the number of antennas used for performing the short-range wireless communication among the plurality of antennas as part of an operation of reducing heat generation. When the number of antennas used for performing the short-range wireless communication is adjusted (or reduced), the number of signals that require amplification by the communication circuitry 310 may be reduced, the communication circuitry 310 may reduce power used to amplify a signal, and heat generation may also be reduced as power consumption is reduced.

The electronic device 100 may receive capability information about the external electronic device 200 through the short-range wireless communication. The capability information about the external electronic device 200 may refer to information indicating a function that the external electronic device 200 supports or does not support among various functions of the short-range wireless communication. The capability information about the external electronic device 200 may be received during a process (e.g., a discovery process or an association process) in which the electronic device 100 and the external electronic device 200 establish the connection through the short-range wireless communication, and may be included in a frame (e.g., an action frame) transmitted by the external electronic device 200 after the electronic device 100 and the external electronic device 200 complete the connection through the short-range wireless communication. According to an embodiment, the capability information about the external electronic device 200 may be included in a header of a signal transmitted through a medium access control (MAC) layer.

According to an embodiment, the capability information about the external electronic device 200 may include information indicating whether to support a function related to transmission and/or reception of a signal using the plurality of antennas. According to an embodiment, the capability information about the external electronic device 200 may include the number (N_{SS}) of spatial streams supported by the external electronic device 200. When receiving the capability information about the external electronic device 200 in which the number of spatial streams supported by the external electronic device 200 is indicated (or displayed) as 1, the electronic device 100 may identify that the external electronic device 200 does not support transmission and/or reception of a signal using the plurality of antennas.

The electronic device 100 may reduce the strength of a signal output through the plurality of antennas as part of the operation of reducing heat generation. When the temperature of the electronic device 100 is a specified value or higher, the electronic device 100 may identify the quality of the signal transmitted by the external electronic device 200 through the short-range wireless communication. The signal transmitted by the external electronic device 200 through the short-range wireless communication may be any one of various signals transmitted through the short-range wireless communication, and for example, the signal transmitted by the external electronic device 200 through the short-range wireless communication may be a signal including data related to the vehicle or a control signal (e.g., a beacon signal) of the short-range wireless communication.

According to an embodiment, the electronic device 100 may identify the quality of the signal by identifying a parameter (e.g., a received signal strength indicator (RSSI), a signal-to-noise ratio (SNR), a link speed, and/or an estimated throughput) indicating the quality of the signal.

In operation 630, the electronic device 100 may adjust the number of antennas for performing the short-range wireless communication, based on capability information about the external electronic device 200 and the quality of the signal transmitted by the external electronic device 200.

When the external electronic device 200 does not support the short-range wireless communication using a plurality of spatial streams (or when the number of spatial streams supported by the external electronic device 200 is 1), the electronic device 100 may control the communication circuitry 310 to perform the short-range wireless communication through one of the plurality of antennas. Performing the short-range wireless communication through one of the plurality of antennas may refer to the communication circuitry 310 operating in the SISO mode. When the temperature of the electronic device 100 is equal to or higher than (or exceeds) the specified value and the external electronic device 200 does not support the short-range wireless communication using the plurality of spatial streams (or when the number of spatial streams supported by the external electronic device 200 is 1), the electronic device 100 may control the communication circuitry 310 to perform the short-range wireless communication through one of the plurality of antennas.

According to an embodiment, the electronic device 100 may control the communication circuitry 310 to perform the short-range wireless communication through an antenna capable of exhibiting the highest performance among the plurality of antennas. The electronic device 100 may identify the quality of a signal received through the plurality of antennas, and may control the communication circuitry 310 to perform the short-range wireless communication through an antenna that has received a signal with the highest quality.

According to an embodiment, when performing the short-range wireless communication through one antenna among the plurality of antennas, the electronic device 100 may determine (or calculate, estimate, or identify) a throughput (estimated throughput). When the estimated throughput is greater than the volume of traffic transmitted and/or received through the short-range wireless communication, the electronic device 100 may perform the short-range wireless communication by using one antenna. When the estimated throughput is less than the volume of traffic transmitted and/or received through the short-range wireless communication, the electronic device 100 may control the communication circuitry 310 to perform the short-range wireless communication by using the plurality of antennas.

According to an embodiment, when the external electronic device 200 does not support the short-range wireless communication using the plurality of spatial streams (or the number of spatial streams supported by the external electronic device 200 is 1) and the quality of the signal transmitted by the external electronic device 200 is equal to or greater than (or exceeds) a specified value, the electronic device 100 may control the communication circuitry 310 to perform the short-range wireless communication through one antenna of the plurality of antennas. The quality of the signal transmitted by the external electronic device 200 being equal to or greater than (or exceeds) the specified value means that the quality of the short-range wireless communication performed by the electronic device 100 and the external electronic device 200 is high, in which case the quality of the short-range wireless communication may satisfy a required quality even when the short-range wireless communication is performed using one antenna. Therefore, the electronic device 100 may control the communication circuitry 310 to perform the short-range wireless communication through one antenna of the plurality of antennas, thereby reducing power used by the communication circuitry 310 and reducing heat generation.

According to an embodiment, when the external electronic device 200 does not support the short-range wireless communication using the plurality of spatial streams (or the number of spatial streams supported by the external electronic device 200 is 1) and the quality of the signal transmitted by the external electronic device 200 is less than or equal to (or below) the specified value, the electronic device 100 may control the communication circuitry 310 to receive a signal using two or more antennas among the plurality of antennas and transmit a signal to the external electronic device 200 using at least two or more antennas. Receiving a signal using two or more antennas among the plurality of antennas is for supporting a diversity Rx mode. The electronic device 100 may receive a signal by using two or more antennas among the plurality of antennas, thereby improving performance in receiving the signal transmitted by the external electronic device 200.

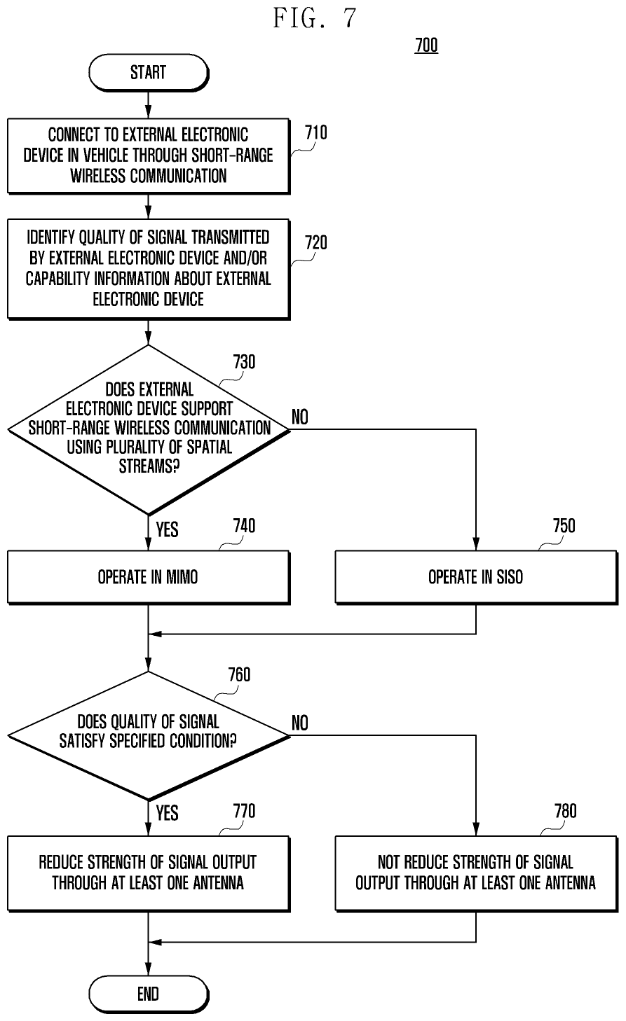

FIG. 7 is a flowchart illustrating an example in which an electronic device adjusts a strength of a signal output through a plurality of antennas and a number of antennas for performing short-range wireless communication, based on the quality of a signal transmitted by an external electronic device and/or capability information about the external electronic device according to an embodiment of the disclosure.

Referring to the flowchart 700 of FIG. 7, in operation 710, the electronic device (e.g., the electronic device 100 of FIG. 3) may be connected to the external electronic device (e.g., the external electronic device 200 of FIG. 2) in a vehicle through short-range wireless communication.

According to an embodiment, the external electronic device 200 may be an electronic device included in a vehicle (e.g., a car or a motorcycle), and may be an electronic device supporting short-range wireless communication. For example, the external electronic device 200 may be an electronic device included in a vehicle, and may be an electronic device capable of controlling a function that the vehicle is able to provide (e.g., an air conditioning function, a content providing function, a function of controlling the vehicle, and/or a control function using a voice command). When the external electronic device 200 is configured as an electronic device included in a vehicle, the external electronic device 200 may be referred to by various terms, such as a car kit, an infotainment system, or a head unit.

The electronic device 100 may retrieve the external electronic device 200 to perform a service related to the vehicle. The service related to the vehicle may include, for example, a navigation service for guiding the vehicle to a destination or a content playback service (or a content streaming service) of outputting content by using an output device (e.g., a speaker or a display) included in the vehicle. To perform the service related to the vehicle in association with the external electronic device 200, the electronic device 100 may be required to connect with the external electronic device 200 via the short-range wireless communication, and may perform an operation of connecting to the external electronic device 200 through the short-range wireless communication.

The electronic device 100 may perform an authentication procedure, an association procedure, and/or a security configuration procedure with the external electronic device 200 upon discovering the external electronic device 200, and may complete a connection with the external electronic device 200 through the short-range wireless communication upon completing the foregoing procedures.

The electronic device 100 may complete the connection with the external electronic device 200 through the short-range wireless communication, may control the communication circuitry 310 to transmit data related to the service related to the vehicle to the external electronic device 200 through the short-range wireless communication, and may receive data related to the service related to the vehicle from the external electronic device 200.

In operation 720, the electronic device 100 may identify the quality of a signal transmitted by the external electronic device 200 and capability information about the external electronic device 200.

The electronic device 100 may adjust (or reduce) the number of antennas used for performing the short-range wireless communication among the plurality of antennas as part of an operation of reducing heat generation. When the number of antennas used for performing the short-range wireless communication is adjusted (or reduced), the number of signals that require amplification by the communication circuitry 310 may be reduced, the communication circuitry 310 may reduce power used to amplify a signal, and heat generation may also be reduced as power consumption is reduced.

The electronic device 100 may receive capability information about the external electronic device 200 through the short-range wireless communication. The capability information about the external electronic device 200 may refer to information indicating a function that the external electronic device 200 supports or does not support among various functions of the short-range wireless communication. The capability information about the external electronic device 200 may be received during a process (e.g., a discovery process or an association process) in which the electronic device 100 and the external electronic device 200 establish the connection through the short-range wireless communication, and may be included in a frame (e.g., an action frame) transmitted by the external electronic device 200 after the electronic device 100 and the external electronic device 200 complete the connection through the short-range wireless communication. According to an embodiment, the capability information about the external electronic device 200 may be included in a header of a signal transmitted through a medium access control (MAC) layer.

According to an embodiment, the capability information about the external electronic device 200 may include information indicating whether to support a function related to transmission and/or reception of a signal using the plurality of antennas. According to an embodiment, the capability information about the external electronic device 200 may include the number (N_{SS}) of spatial streams supported by the external electronic device 200. When receiving the capability information about the external electronic device 200 in which the number of spatial streams supported by the external electronic device 200 is indicated (or displayed) as 1, the electronic device 100 may identify that the external electronic device 200 does not support transmission and/or reception of a signal using the plurality of antennas.

The electronic device 100 may reduce the strength of a signal output through the plurality of antennas as part of the operation of reducing heat generation. When the temperature of the electronic device 100 is a specified value or higher, the electronic device 100 may identify the quality of the signal transmitted by the external electronic device 200 through the short-range wireless communication. The signal transmitted by the external electronic device 200 through the short-range wireless communication may be any one of various signals transmitted through the short-range wireless communication, and for example, the signal transmitted by the external electronic device 200 through the short-range wireless communication may be a signal including data related to the vehicle or a control signal (e.g., a beacon signal) of the short-range wireless communication.

According to an embodiment, the electronic device 100 may identify the quality of the signal by identifying a parameter (e.g., a received signal strength indicator (RSSI), a signal-to-noise ratio (SNR), a link speed, and/or an estimated throughput) indicating the quality of the signal.

In operation 730, the electronic device 100 may identify whether the external electronic device 200 supports the short-range wireless communication using a plurality of spatial streams.

According to an embodiment, the capability information about the external electronic device 200 may include information indicating whether to support a function related to transmission and/or reception of a signal using the plurality of antennas. According to an embodiment, the capability information about the external electronic device 200 may include the number (N_{SS}) of spatial streams supported by the external electronic device 200. When receiving the capability information about the external electronic device 200 in which the number of spatial streams supported by the external electronic device 200 is indicated (or displayed) as 1, the electronic device 100 may identify that the external electronic device 200 does not support transmission and/or reception of a signal using the plurality of antennas.

In operation 740, the electronic device 100 may operate in the MIMO mode, based on the external electronic device 200 supporting the short-range wireless communication using the plurality of spatial streams (operation 730-Y).

When the external electronic device 200 supports the short-range wireless communication using the plurality of spatial streams (or when the number of spatial streams supported by the external electronic device 200 is a number other than 1), the electronic device 100 may control the communication circuitry 310 to perform the short-range wireless communication through the plurality of antennas. Performing the short-range wireless communication through the plurality of antennas may refer to the communication circuitry 310 operating in the MIMO mode.

In operation 750, the electronic device 100 may operate in the SISO mode, based on the external electronic device 200 not supporting the short-range wireless communication using the plurality of spatial streams (operation 730-N).

When the external electronic device 200 does not support the short-range wireless communication using the plurality of spatial streams (or when the number of spatial streams supported by the external electronic device 200 is 1), the electronic device 100 may control the communication circuitry 310 to perform the short-range wireless communication through one antenna among the plurality of antennas. Performing the short-range wireless communication through one antenna among the plurality of antennas may refer to the communication circuitry 310 operating in the SISO mode.

In operation 760, the electronic device 100 may identify whether the quality of the signal satisfies a specified condition.

The specified condition may include a condition that the quality of the signal is equal to or greater than (or exceeds) a specified value.

The electronic device 100 may identify the quality of the signal received from the external electronic device 200, and may identify whether the quality of the signal satisfies the specified condition.

In operation 770, the electronic device 100 may reduce the strength of a signal output through at least one antenna, based on the quality of the signal satisfying the specified condition.

According to an embodiment, when the external electronic device 200 does not support the short-range wireless communication using the plurality of spatial streams (or when the number of spatial streams supported by the external electronic device 200 is 1) and the quality of the signal transmitted by the external electronic device 200 is equal to or greater than (or exceeds) the specified value, the electronic device 100 may control the communication circuitry 310 to perform the short-range wireless communication through one antenna of the plurality of antennas and to reduce the strength of the signal output through the one antenna. The quality of the signal transmitted by the external electronic device 200 being equal to or greater than (or exceeds) the specified value means that the quality of the short-range wireless communication performed by the electronic device 100 and the external electronic device 200 is high, in which case the quality of the short-range wireless communication may satisfy a required quality even when the short-range wireless communication is performed using one antenna. Therefore, the electronic device 100 may control the communication circuitry 310 to perform the short-range wireless communication through one antenna of the plurality of antennas, thereby reducing power used by the communication circuitry 310 and reducing heat generation.

According to an embodiment, when the external electronic device 200 supports the short-range wireless communication using the plurality of spatial streams and the quality of the signal transmitted by the external electronic device 200 is equal to or greater than (or exceeds) the specified value, the electronic device 100 may control the communication circuitry 310 to perform the short-range wireless communication through the plurality of antennas and to reduce the strength of a signal output through the plurality of antennas.

After reducing the strength of the signal, the electronic device 100 may control the communication circuitry 310 to increase the strength of the signal again, based on identifying that the quality of the signal received from the external electronic device 200 is reduced.

In operation 780, the electronic device 100 may not reduce the strength of the signal output through the at least one antenna, based on the quality of the signal not satisfying the specified condition (operation 760-N).

According to an embodiment, when the external electronic device 200 does not support the short-range wireless communication using the plurality of spatial streams (or when the number of spatial streams supported by the external electronic device 200 is 1) and the quality of the signal transmitted by the external electronic device 200 is less than or equal to (or below) the specified value, the electronic device 100 may control the communication circuitry 310 to receive a signal by using two or more antennas among the plurality of antennas and to transmit a signal to the external electronic device 200 by using one antenna, and may control the communication circuitry 310 to refrain from an operation of reducing the strength of the signal output through the one antenna.

According to an embodiment, when the external electronic device 200 supports the short-range wireless communication using the plurality of spatial streams and the quality of the signal transmitted by the external electronic device 200 is less than or equal to (or below) the specified value, the electronic device 100 may control the communication circuitry 310 to receive a signal by using the plurality of antennas and to transmit a signal to the external electronic device 200 by using the plurality of antennas, and may control the communication circuitry 310 to refrain from an operation of reducing the strength of the signal output through the plurality of antennas.

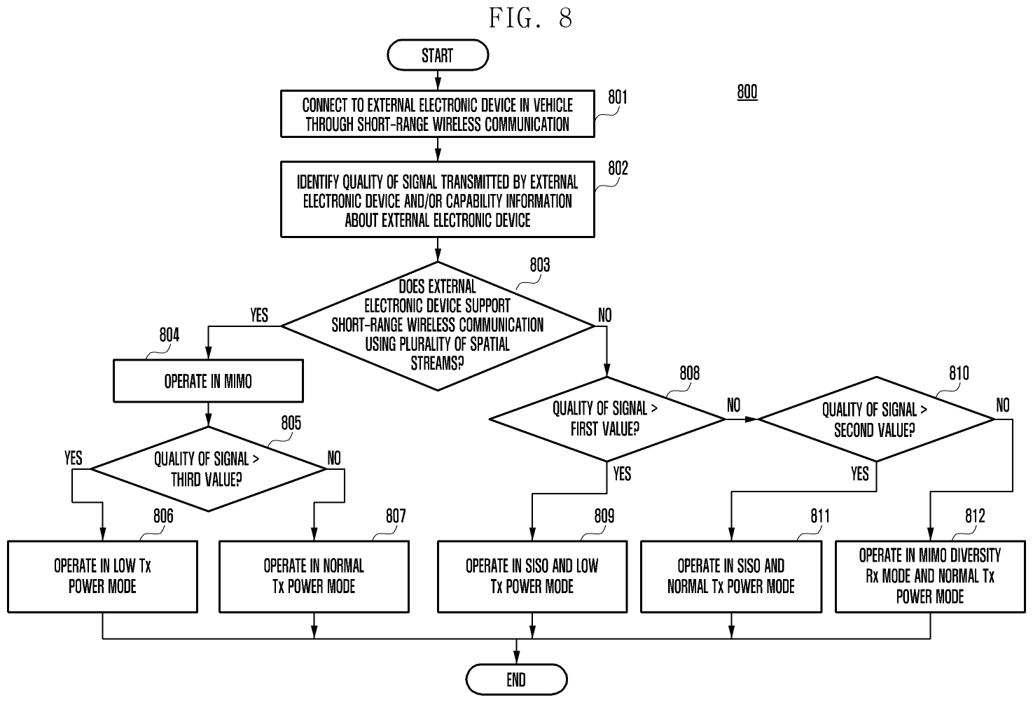

FIG. 8 is a flowchart illustrating an example in which an electronic device adjusts a strength of a signal output through a plurality of antennas and a number of antennas for performing short-range wireless communication, based on the quality of a signal transmitted by an external electronic device and/or capability information about the external electronic device according to an embodiment of the disclosure.

Referring to the flowchart 800 of FIG. 8, in operation 801, the electronic device (e.g., the electronic device 100 of FIG. 3) may be connected to the external electronic device (e.g., the external electronic device 200 of FIG. 2) in a vehicle through short-range wireless communication.

According to an embodiment, the external electronic device 200 may be an electronic device included in a vehicle (e.g., a car or a motorcycle), and may be an electronic device supporting short-range wireless communication. For example, the external electronic device 200 may be an electronic device included in a vehicle, and may be an electronic device capable of controlling a function that the vehicle is able to provide (e.g., an air conditioning function, a content providing function, a function of controlling the vehicle, and/or a control function using a voice command). When the external electronic device 200 is configured as an electronic device included in a vehicle, the external electronic device 200 may be referred to by various terms, such as a car kit, an infotainment system, or a head unit.

The electronic device 100 may retrieve the external electronic device 200 to perform a service related to the vehicle. The service related to the vehicle may include, for example, a navigation service for guiding the vehicle to a destination or a content playback service (or a content streaming service) of outputting content by using an output device (e.g., a speaker or a display) included in the vehicle. To perform the service related to the vehicle in association with the external electronic device 200, the electronic device 100 may be required to connect with the external electronic device 200 via the short-range wireless communication, and may perform an operation of connecting to the external electronic device 200 through the short-range wireless communication.

The electronic device 100 may perform an authentication procedure, an association procedure, and/or a security configuration procedure with the external electronic device 200 upon discovering the external electronic device 200, and may complete a connection with the external electronic device 200 through the short-range wireless communication upon completing the foregoing procedures.

The electronic device 100 may complete the connection with the external electronic device 200 through the short-range wireless communication, may control the communication circuitry 310 to transmit data related to the service related to the vehicle to the external electronic device 200 through the short-range wireless communication, and may receive data related to the service related to the vehicle from the external electronic device 200.

In operation 802, the electronic device 100 may identify the quality of a signal transmitted by the external electronic device 200 and capability information about the external electronic device 200.

The electronic device 100 may adjust (or reduce) the number of antennas used for performing the short-range wireless communication among the plurality of antennas as part of an operation of reducing heat generation. When the number of antennas used for performing the short-range wireless communication is adjusted (or reduced), the number of signals that require amplification by the communication circuitry 310 may be reduced, the communication circuitry 310 may reduce power used to amplify a signal, and heat generation may also be reduced as power consumption is reduced.

The electronic device 100 may receive capability information about the external electronic device 200 through the short-range wireless communication. The capability information about the external electronic device 200 may refer to information indicating a function that the external electronic device 200 supports or does not support among various functions of the short-range wireless communication. The capability information about the external electronic device 200 may be received during a process (e.g., a discovery process or an association process) in which the electronic device 100 and the external electronic device 200 establish the connection through the short-range wireless communication, and may be included in a frame (e.g., an action frame) transmitted by the external electronic device 200 after the electronic device 100 and the external electronic device 200 complete the connection through the short-range wireless communication. According to an embodiment, the capability information about the external electronic device 200 may be included in a header of a signal transmitted through a medium access control (MAC) layer.

According to an embodiment, the capability information about the external electronic device 200 may include information indicating whether to support a function related to transmission and/or reception of a signal using the plurality of antennas. According to an embodiment, the capability information about the external electronic device 200 may include the number (N_{SS}) of spatial streams supported by the external electronic device 200. When receiving the capability information about the external electronic device 200 in which the number of spatial streams supported by the external electronic device 200 is indicated (or displayed) as 1, the electronic device 100 may identify that the external electronic device 200 does not support transmission and/or reception of a signal using the plurality of antennas.

The electronic device 100 may reduce the strength of a signal output through the plurality of antennas as part of the operation of reducing heat generation. When the temperature of the electronic device 100 is a specified value or higher, the electronic device 100 may identify the quality of the signal transmitted by the external electronic device 200 through the short-range wireless communication. The signal transmitted by the external electronic device 200 through the short-range wireless communication may be any one of various signals transmitted through the short-range wireless communication, and for example, the signal transmitted by the external electronic device 200 through the short-range wireless communication may be a signal including data related to the vehicle or a control signal (e.g., a beacon signal) of the short-range wireless communication.

According to an embodiment, the electronic device 100 may identify the quality of the signal by identifying a parameter (e.g., a received signal strength indicator (RSSI), a signal-to-noise ratio (SNR), a link speed, and/or an estimated throughput) indicating the quality of the signal.

In operation 803, the electronic device 100 may identify whether the external electronic device 200 supports the short-range wireless communication using a plurality of spatial streams.

According to an embodiment, the capability information about the external electronic device 200 may include information indicating whether to support a function related to transmission and/or reception of a signal using the plurality of antennas. According to an embodiment, the capability information about the external electronic device 200 may include the number (N_{SS}) of spatial streams supported by the external electronic device 200. When receiving the capability information about the external electronic device 200 in which the number of spatial streams supported by the external electronic device 200 is indicated (or displayed) as 1, the electronic device 100 may identify that the external electronic device 200 does not support transmission and/or reception of a signal using the plurality of antennas.

In operation 804, the electronic device 100 may operate in the MIMO mode, based on the external electronic device 200 supporting the short-range wireless communication using the plurality of spatial streams (operation 803-Y).

When the external electronic device 200 supports the short-range wireless communication using the plurality of spatial streams (or when the number of spatial streams supported by the external electronic device 200 is a number other than 1), the electronic device 100 may control the communication circuitry 310 to perform the short-range wireless communication through the plurality of antennas. Performing the short-range wireless communication through the plurality of antennas may refer to the communication circuitry 310 operating in the MIMO mode.

In operation 805, the electronic device 100 may identify whether the quality of the signal transmitted by the external electronic device 200 is equal to or greater than (or exceeds) a third value.

The third value may refer to a signal quality such that the throughput of data transmitted and/or received through the short-range wireless communication may be equal to or greater than a required throughput even though the electronic device 100 and the external electronic device 200 reduce the strength of a signal to be transmitted while operating in the MIMO mode.

In operation 806, the electronic device 100 may operate in a mode (low Tx power mode) of reducing the level of the signal output by the plurality of antennas, based on the quality of the signal transmitted by the external electronic device 200 being equal to or greater than (or exceeds) the third value (operation 805-Y).

When the quality of the signal is equal to or greater than (or exceeds) the third value and the external electronic device 200 supports the short-range wireless communication using the plurality of spatial streams, the electronic device 100 may control the communication circuitry 310 to perform transmission and/or reception of a signal using the plurality of antennas and to reduce the strength of a signal transmitted through the plurality of antennas.

In operation 807, the electronic device 100 may operate in a mode (normal Tx power mode) of not reducing the level of the signal output through the plurality of antennas, based on the quality of the signal transmitted by the external electronic device 200 being less than (or less than or equal to) the third value (operation 805-N).

When the quality of the signal is less than (or less than or equal to) the third value and the external electronic device 200 supports the short-range wireless communication using the plurality of spatial streams, the electronic device 100 may control the communication circuitry 310 to refrain from reducing the strength of a signal transmitted through the plurality of antennas and to perform transmission and/or reception of a signal using the plurality of antennas.

In operation 808, the electronic device 100 may identify whether the quality of the signal transmitted by the external electronic device 200 is equal to or greater than a first value, based on the external electronic device 200 not supporting the short-range wireless communication using the plurality of spatial streams (operation 803-N).

The first value may refer to a signal quality such that the throughput of data transmitted and/or received through the short-range wireless communication may be equal to or greater than the required throughput even though the electronic device 100 and the external electronic device 200 reduce the strength of a signal to be transmitted while performing the short-range wireless communication through a single antenna.

In operation 809, the electronic device 100 may control the communication circuitry 310 to operate in the SISO mode and a mode (low Tx power mode) of reducing the strength of a signal output through one antenna, based on the quality of the signal transmitted by the external electronic device 200 being equal to or greater than (or exceeding) the first value (operation 808-Y).

When the quality of the signal transmitted by the external electronic device 200 is equal to or greater than (or exceeds) the first value and the external electronic device 200 does not support the short-range wireless communication using the plurality of spatial streams, the electronic device 100 may control the communication circuitry 310 to perform transmission and/or reception of a signal using one antenna (SISO mode) and to reduce the strength of a signal output through one antenna (low Tx power mode).

In operation 810, the electronic device 100 may identify whether the quality of the signal transmitted by the external electronic device 200 is equal to or greater than (or exceeds) a second value, based on the quality of the signal transmitted by the external electronic device 200 being below (or less than or equal to) the first value (operation 808-N).

The second value may refer to a signal quality corresponding to the required minimum throughput of data to be received by the electronic device 100 when the electronic device 100 and the external electronic device 200 receive a signal by using one antenna. When the electronic device 100 receives a signal having a quality equal to or greater than the second value, the electronic device 100 may satisfy the required minimum throughput even when receiving the signal through one antenna. When the electronic device 100 receives a signal having a quality equal to or less than (or below) the second value, the electronic device 100 may need to receive the signal through at least two or more antennas.

In operation 811, the electronic device 100 may control the communication circuitry 310 to operate in the SISO mode and a mode (normal Tx power mode) of not reducing the strength of a signal output through one antenna, based on the quality of the signal transmitted by the external electronic device 200 being equal to or greater than (or exceeding) the second value (operation 810-Y).

When the quality of the signal transmitted by the external electronic device 200 is less than or equal to (or below) the first size and equal to or greater than (or exceeds) the second value that is smaller than the first value and the external electronic device 200 does not support the short-range wireless communication using the plurality of spatial streams, the electronic device 100 may control the communication circuitry 310 to refrain from reducing the strength of a signal output through one antenna and to perform transmission and/or reception of a signal using one antenna.

In operation 812, the electronic device 100, may control the communication circuitry 310 to operate in a MIMO diversity Rx mode and the mode (normal Tx power mode) of not reducing the strength of the signal output through the one antenna, based on the quality of the signal transmitted by the external electronic device 200 being less than or equal to (or below) the second value (operation 810-N).

When the quality of the signal transmitted by the external electronic device 200 is less than or equal to (or below) the second value and the external electronic device 200 does not support the short-range wireless communication using the plurality of spatial streams, the electronic device 100 may control the communication circuitry 310 to refrain from reducing the strength of a signal output through one antenna and to perform transmission of a signal using one antenna and reception of a signal using two or more antennas among the plurality of antennas. Receiving a signal using two or more antennas among the plurality of antennas is for supporting the diversity Rx mode. The electronic device 100 may receive a signal by using two or more antennas among the plurality of antennas, thereby improving performance in receiving the signal transmitted by the external electronic device 200. Further, since the external electronic device 200 is unable to receive a signal through a plurality of antennas, the electronic device 100 may output a signal by using one antenna

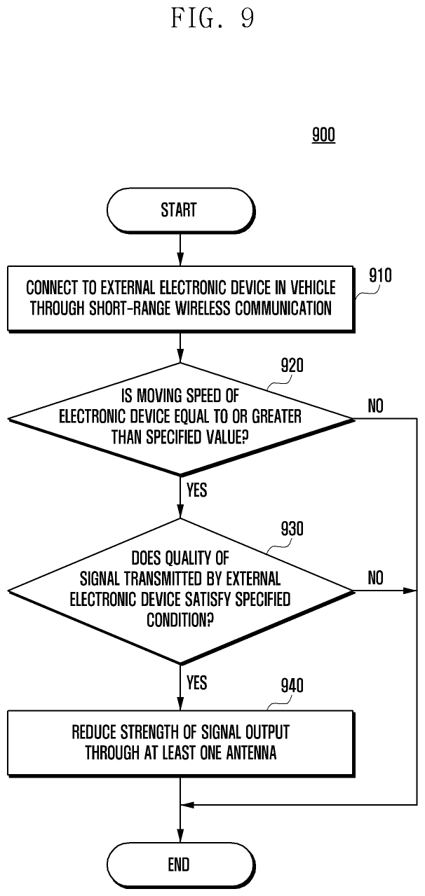

FIG. 9 is a flowchart illustrating an example in which an electronic device reduces a strength of a signal output through at least one antenna, based on a moving speed of the electronic device and the quality of a signal transmitted by an external electronic device according to an embodiment of the disclosure.

Referring to flowchart 900 of FIG. 9, in operation 910, the electronic device (e.g., the electronic device 100 of FIG. 3) may be connected to an external electronic device (e.g., the external electronic device 200 of FIG. 2) in a vehicle through short-range wireless communication.

According to an embodiment, the external electronic device 200 may be an electronic device included in a vehicle (e.g., a car or a motorcycle), and may be an electronic device supporting short-range wireless communication. For example, the external electronic device 200 may be an electronic device included in a vehicle, and may be an electronic device capable of controlling a function that the vehicle is able to provide (e.g., an air conditioning function, a content providing function, a function of controlling the vehicle, and/or a control function using a voice command). When the external electronic device 200 is configured as an electronic device included in a vehicle, the external electronic device 200 may be referred to by various terms, such as a car kit, an infotainment system, or a head unit.

The electronic device 100 may retrieve the external electronic device 200 to perform a service related to the vehicle. The service related to the vehicle may include, for example, a navigation service for guiding the vehicle to a destination or a content playback service (or a content streaming service) of outputting content by using an output device (e.g., a speaker or a display) included in the vehicle. To perform the service related to the vehicle in association with the external electronic device 200, the electronic device 100 may be required to connect with the external electronic device 200 via the short-range wireless communication, and may perform an operation of connecting to the external electronic device 200 through the short-range wireless communication.

The electronic device 100 may perform an authentication procedure, an association procedure, and/or a security configuration procedure with the external electronic device 200 upon discovering the external electronic device 200, and may complete a connection with the external electronic device 200 through the short-range wireless communication upon completing the foregoing procedures.

The electronic device 100 may complete the connection with the external electronic device 200 through the short-range wireless communication, may control the communication circuitry 310 to transmit data related to the service related to the vehicle to the external electronic device 200 through the short-range wireless communication, and may receive data related to the service related to the vehicle from the external electronic device 200.

In operation 920, the electronic device 100 may identify whether the moving speed of the electronic device 100 is equal to or greater than a specified value.

The specified value is a value for determining whether the electronic device 100 exists inside the vehicle, and when the moving speed of the electronic device 100 is equal to or greater than the specified value, the electronic device 100 may determine that the electronic device 100 exists inside the vehicle and perform the following operations.

In operation 930, the electronic device 100 may identify whether the quality of a signal transmitted by the external electronic device 200 satisfies a specified condition.

The specified condition may include may include a condition that the quality of the signal is equal to or greater than (or exceeds) a specified value.

According to an embodiment, the electronic device 100 may identify the quality of the signal by identifying a parameter (e.g., a received signal strength indicator (RSSI), a signal-to-noise ratio (SNR), a link speed, and/or an estimated throughput) indicating the quality of the signal.

In operation 940, the electronic device 100 may reduce the strength of a signal output through at least one antenna, based on the quality of the signal transmitted by the external electronic device 200 satisfying the specified condition (operation 930-Y).

The electronic device 100 may identify whether the quality of the signal transmitted by the external electronic device 200 through the short-range wireless communication is equal to or greater than (or exceeds) the specified value, and may reduce the strength of a signal output through a plurality of antennas when the quality of the signal transmitted by the external electronic device 200 through the short-range wireless communication is equal to or greater than (or exceeds) the specified value. The specified value may refer to a level (or value) indicating (or denoting) that the electronic device 100 and the external electronic device 200 may smoothly perform the short-range wireless communication. The quality of the signal transmitted by the external electronic device 200 through the short-range wireless communication being equal to or greater than (or exceeds) the specified value may indicate a situation in which the electronic device 100 and the external electronic device 200 may smoothly perform the short-range wireless communication. Therefore, the processor 320 may control the communication unit 310 to reduce the strength of the signal output through the plurality antennas. The communication circuitry 310 may reduce the strength of the signal output through the antennas to thereby reduce power required to amplify the signal, and heat generation may also be reduced as power consumption is reduced.

An electronic device according to an embodiment may include a plurality of antennas. The electronic device may include communication circuitry 310 supporting short-range wireless communication. The electronic device may include memory 330 storing at least one computer program. The electronic device may include at least one processor 320. The at least one computer program may include instructions that, when separately or collectively executed by the at least one processor 320, cause the electronic device to connect to an external electronic device 200 disposed in a vehicle through the short-range wireless communication. The instructions may, when separately or collectively executed by the at least one processor 320, cause the electronic device to control the communication circuitry 310 to reduce a strength of a signal output through the plurality of antennas, based on a temperature of the electronic device being equal to or greater than a specified value and a quality of a signal transmitted by the external electronic device 200 being equal to or greater than a first value.

In the electronic device according to an embodiment, the instructions may, when separately or collectively executed by the at least one processor 320, cause the electronic device to receive capability information about the external electronic device 200 through the short-range wireless communication. The instructions may, when separately or collectively executed by the at least one processor 320, cause the electronic device to control the communication circuitry 310 to perform the short-range wireless communication by using a single antenna among the plurality of the antennas when identifying that the external electronic device 200 does not support short-range wireless communication using a plurality of spatial streams, based on the capability information about the external electronic device 200.

In the electronic device according to an embodiment, the instructions may, when separately or collectively executed by the at least one processor 320, cause the electronic device to receive the capability information about the external electronic device 200 through the short-range wireless communication. The instructions may, when separately or collectively executed by the at least one processor 320, cause the electronic device to activate a diversity Rx mode using the plurality of the antennas when identifying that the external electronic device 200 does not support the short-range wireless communication using the plurality of spatial streams and the quality of the signal transmitted by the external electronic device 200 is less than or equal to a second value that is smaller than the first value, based on the capability information about the external electronic device 200.

In the electronic device according to an embodiment, the instructions may, when separately or collectively executed by the at least one processor 320, cause the electronic device to perform the short-range wireless communication using the single antenna among the plurality of the antennas when identifying that the external electronic device 200 does not support the short-range wireless communication using the plurality of spatial streams and the quality of the signal transmitted by the external electronic 200 device is equal to or greater than the second value and is less than or equal to the first value.

In the electronic device according to an embodiment, the instructions may, when separately or collectively executed by the at least one processor 320, cause the electronic device to identify the temperature of the electronic device and the quality of the signal transmitted by the external electronic device 200 when the electronic device is being charged.

In the electronic device according to an embodiment, the instructions may, when separately or collectively executed by the at least one processor 320, cause the electronic device to refrain from reducing the strength of the signal transmitted through the plurality of the antennas when the electronic device is not being charged.

In the electronic device according to an embodiment, the instructions may, when separately or collectively executed by the at least one processor 320, cause the electronic device to transmit a signal for requesting a reduction in a strength of the signal transmitted by the external electronic device 200 to the external electronic device 200, based on the quality of the signal transmitted by the external electronic device 200 being equal to or greater than the first value.

In the electronic device according to an embodiment, the instructions may, when separately or collectively executed by the at least one processor 320, cause the electronic device to identify the quality of the signal transmitted by the external electronic device 200, based on identifying that the temperature of the electronic device is equal to or greater than the specified value and a moving speed of the electronic device is equal to or greater than a specified value.

In the electronic device according to an embodiment, the instructions may, when separately or collectively executed by the at least one processor 320, cause the electronic device to control the communication circuitry 310 to reduce the strength of the signal transmitted through the plurality of antennas, based on the electronic device performing a service related to the external electronic device 200 and the quality of the signal transmitted by the external electronic device 200 being equal to or greater than the first value.

A recording medium may store at least one program including instructions to, when separately or collectively executed by at least one processor 320 of the electronic device, cause the electronic device to perform operations, wherein the instructions may, when separately or collectively executed by the at least one processor 320, cause the electronic device to connect to an external electronic device 200 disposed in a vehicle through short-range wireless communication. The instructions may, when separately or collectively executed by the at least one processor 320, cause the electronic device to reduce a strength of a signal output through the plurality of antennas, based on a temperature of the electronic device being equal to or greater than a specified value and a quality of a signal transmitted by the external electronic device 200 being equal to or greater than a first value.

In the recording medium according to an embodiment, the instructions may, when separately or collectively executed by the at least one processor 320, cause the electronic device to receive capability information about the external electronic device 200 through the short-range wireless communication. The instructions may, when separately or collectively executed by the at least one processor 320, cause the electronic device to control the communication circuitry 310 to perform the short-range wireless communication by using a single antenna among the plurality of the antennas when identifying that the external electronic device 200 does not support short-range wireless communication using a plurality of spatial streams, based on the capability information about the external electronic device 200.

In the recording medium according to an embodiment, the instructions may, when separately or collectively executed by the at least one processor 320, cause the electronic device to receive the capability information about the external electronic device 200 through the short-range wireless communication. The instructions may, when separately or collectively executed by the at least one processor 320, cause the electronic device to activate a diversity Rx mode using the plurality of the antennas when the external electronic device 200 does not support the short-range wireless communication using the plurality of spatial streams and the quality of the signal transmitted by the external electronic device 200 is less than or equal to a second value that is smaller than the first value, based on the capability information about the external electronic device 200.

In the recording medium according to an embodiment, the instructions may, when separately or collectively executed by the at least one processor 320, cause the electronic device to perform the short-range wireless communication using the single antenna among the plurality of the antennas when identifying that the external electronic device 200 does not support short-range wireless communication using two or more spatial streams and the quality of the signal transmitted by the external electronic 200 device is equal to or greater than the second value and is less than or equal to the first value.

In the recording medium according to an embodiment, the instructions may, when separately or collectively executed by the at least one processor 320, cause the electronic device to identify the temperature of the electronic device and the quality of the signal transmitted by the external electronic device 200 when the electronic device is being charged.

In the recording medium according to an embodiment, the instructions may, when separately or collectively executed by the at least one processor 320, cause the electronic device to refrain from reducing the strength of the signal transmitted through the plurality of the antennas when the electronic device is not being charged.

In the recording medium according to an embodiment, the instructions may, when separately or collectively executed by the at least one processor 320, cause the electronic device to transmit a signal for requesting a reduction in a strength of the signal transmitted by the external electronic device 200 to the external electronic device 200, based on the quality of the signal transmitted by the external electronic device 200 being equal to or greater than the first value.

In the recording medium according to an embodiment, the instructions may, when separately or collectively executed by the at least one processor 320, cause the electronic device to identify the quality of the signal transmitted by the external electronic device 200, based on identifying that the temperature of the electronic device is equal to or greater than the specified value and a moving speed of the electronic device is equal to or greater than a specified value.

In the recording medium according to an embodiment, the instructions may, when separately or collectively executed by the at least one processor 320, cause the electronic device to control the communication circuitry 310 to reduce the strength of the signal transmitted through the plurality of antennas, based on identifying that the temperature of the electronic device is equal to or greater than the specified value and a moving speed of the electronic device is equal to or greater than a specified value.

An operating method of an electronic device according to an embodiment may include connecting to an external electronic device 200 disposed in a vehicle through the short-range wireless communication. The operating method of the electronic device may include reducing a strength of a signal output through the plurality of antennas, based on a temperature of the electronic device being equal to or greater than a specified value and a quality of a signal transmitted by the external electronic device 200 being equal to or greater than a first value.

The operating method of the electronic device may further include receiving capability information about the external electronic device 200 through the short-range wireless communication. The operating method of the electronic device may include performing the short-range wireless communication by using a single antenna among the plurality of the antennas when identifying that the external electronic device 200 does not support short-range wireless communication using a plurality of spatial streams, based on the capability information about the external electronic device 200.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a plurality of antennas,
communication circuitry supporting short-range wireless communication;
memory, comprising one or more storage media, storing instructions; and
at least one processor communicatively coupled to the communication circuitry, and the memory,
wherein the instructions, when executed by the at least one processor individually or collectively, cause the electronic device to:
connect to an external electronic device disposed in a vehicle through the short-range wireless communication, and
control the communication circuitry to reduce a strength of a signal output through the plurality of antennas, based on a temperature of the electronic device being equal to or greater than a specified value and a quality of a signal transmitted by the external electronic device being equal to or greater than a first value.

2. The electronic device of claim 1, wherein the instructions, when executed by the at least one processor individually or collectively, cause the electronic device to:
receive capability information about the external electronic device through the short-range wireless communication; and
control the communication circuitry to perform the short-range wireless communication by using a single antenna among the plurality of the antennas in case of identifying that the external electronic device does not support short-range wireless communication using a plurality of spatial streams, based on the capability information about the external electronic device.

3. The electronic device of claim 2, wherein the instructions, when executed by the at least one processor individually or collectively, cause the electronic device to:
receive the capability information about the external electronic device through the short-range wireless communication; and
activate a diversity Rx mode using the plurality of the antennas in case of identifying that the external electronic device does not support the short-range wireless communication using the plurality of spatial streams and the quality of the signal transmitted by the external electronic device is less than or equal to a second value that is smaller than the first value, based on the capability information about the external electronic device.

4. The electronic device of claim 3, wherein the instructions, when executed by the at least one processor individually or collectively, cause the electronic device to:
perform the short-range wireless communication using the single antenna among the plurality of the antennas in case of identifying that the external electronic device does not support the short-range wireless communication using the plurality of spatial streams and the quality of the signal transmitted by the external electronic device is equal to or greater than the second value and is less than or equal to the first value.

5. The electronic device of claim 1, wherein the instructions, when executed by the at least one processor individually or collectively, cause the electronic device to:
identify the temperature of the electronic device and the quality of the signal transmitted by the external electronic device in case that the electronic device is being charged.

6. The electronic device of claim 1, wherein the instructions, when executed by the at least one processor individually or collectively, cause the electronic device to:
refrain from reducing the strength of the signal transmitted through the plurality of the antennas in case that the electronic device is not being charged.

7. The electronic device of claim 1, wherein the instructions, when executed by the at least one processor individually or collectively, cause the electronic device to:
transmit a signal for requesting a reduction in a strength of the signal transmitted by the external electronic device to the external electronic device, based on the quality of the signal transmitted by the external electronic device being equal to or greater than the first value.

8. The electronic device of claim 1, wherein the instructions, when executed by the at least one processor individually or collectively, cause the electronic device to:
identify the quality of the signal transmitted by the external electronic device, based on identifying that the temperature of the electronic device is equal to or greater than the specified value and a moving speed of the electronic device is equal to or greater than a specified value.

9. The electronic device of claim 1, wherein the instructions, when executed by the at least one processor individually or collectively, cause the electronic device to:
control the communication circuitry to reduce the strength of the signal transmitted through the plurality of antennas, based on the electronic device performing a service related to the external electronic device and the quality of the signal transmitted by the external electronic device being equal to or greater than the first value.

10. One or more non-transitory computer-readable storage media storing at least one program comprising instructions, when executed by at least one processor of an electronic device individually or collectively, cause the electronic device to:
connect to an external electronic device disposed in a vehicle through short-range wireless communication; and
reduce a strength of a signal output through a plurality of antennas of the electronic device, based on a temperature of the electronic device being equal to or greater than a specified value and a quality of a signal transmitted by the external electronic device being equal to or greater than a first value.

11. The one or more non-transitory computer-readable storage media of claim 10, wherein the instructions, when executed by the at least one processor individually or collectively, cause the electronic device to:
receive capability information about the external electronic device through the short-range wireless communication; and
control communication circuitry of the electronic device to perform the short-range wireless communication by using a single antenna among the plurality of the antennas in case of identifying that the external electronic device does not support short-range wireless communication using a plurality of spatial streams, based on the capability information about the external electronic device.

12. The one or more non-transitory computer-readable storage media of claim 11, wherein the instructions, when separately or collectively executed by the at least one processor, cause the electronic device to:
receive the capability information about the external electronic device through the short-range wireless communication; and
activate a diversity Rx mode using the plurality of the antennas in case that the external electronic device does not support the short-range wireless communication using the plurality of spatial streams and the quality of the signal transmitted by the external electronic device is less than or equal to a second value that is smaller than the first value, based on the capability information about the external electronic device.

13. The one or more non-transitory computer-readable storage media of claim 12, wherein the instructions, when separately or collectively executed by the at least one processor, cause the electronic device to:
perform the short-range wireless communication using the single antenna among the plurality of the antennas in case of identifying that the external electronic device does not support short-range wireless communication using two or more spatial streams and the quality of the signal transmitted by the external electronic device is equal to or greater than the second value and is less than or equal to the first value.

14. The one or more non-transitory computer-readable storage media of claim 10, wherein the instructions, when separately or collectively executed by the at least one processor, cause the electronic device to:
identify the temperature of the electronic device and the quality of the signal transmitted by the external electronic device in case that the electronic device is being charged.

15. The one or more non-transitory computer-readable storage media of claim 10, wherein the instructions, when separately or collectively executed by the at least one processor, cause the electronic device to:
refrain from reducing the strength of the signal transmitted through the plurality of the antennas in case that the electronic device is not being charged.

16. The one or more non-transitory computer-readable storage media of claim 10, wherein the instructions, when separately or collectively executed by the at least one processor, cause the electronic device to:
transmit a signal for requesting a reduction in a strength of the signal transmitted by the external electronic device to the external electronic device, based on the quality of the signal transmitted by the external electronic device being equal to or greater than the first value.

17. The one or more non-transitory computer-readable storage media of claim 10, wherein the instructions, when separately or collectively executed by the at least one processor, cause the electronic device to:
identify the quality of the signal transmitted by the external electronic device, based on identifying that the temperature of the electronic device is equal to or greater than the specified value and a moving speed of the electronic device is equal to or greater than a specified value.

18. The one or more non-transitory computer-readable storage media of claim 10, wherein the instructions, when separately or collectively executed by the at least one processor, cause the electronic device to:
control communication circuitry of the electronic device to reduce the strength of the signal transmitted through the plurality of antennas, based on identifying that the temperature of the electronic device is equal to or greater than the specified value and a moving speed of the electronic device is equal to or greater than a specified value.

19. An operating method of an electronic device, the operating method comprising:
connecting to an external electronic device disposed in a vehicle through short-range wireless communication; and
reducing a strength of a signal output through a plurality of antennas, based on a temperature of the electronic device being equal to or greater than a specified value and a quality of a signal transmitted by the external electronic device being equal to or greater than a first value.

20. The operating method of claim 19, further comprising:
receiving capability information about the external electronic device through the short-range wireless communication; and
performing the short-range wireless communication by using a single antenna among the plurality of the antennas in case of identifying that the external electronic device does not support short-range wireless communication using a plurality of spatial streams, based on the capability information about the external electronic device.
